(19) United States
(12) Patent Application Publication
(10) Pub. No.: US 2026/0074869 A1
(43) Pub. Date: Mar. 12, 2026

(54) RSRP REPORTING FOR BEAM MANAGEMENT IN INTER-BAND SSB-LESS SCELL

(71) Applicant: QUALCOMM Incorporated, San Diego, CA (US)

(72) Inventors: Jae Ho RYU, San Diego, CA (US); Konstantinos DIMOU, New York, NY (US); Alexandros MANOLAKOS, Athens (GR); Hari SANKAR, San Diego, CA (US)

(21) Appl. No.: 19/103,817

(22) PCT Filed: Sep. 19, 2023
(86) PCT No.: PCT/US2023/033126

§ 371 Date: Feb. 13, 2025

(30) Foreign Application Priority Data
Oct. 21, 2022 (GR) 20220100865

(51) Int. Cl. H04L 5/00; H04B 7/06

(52) U.S. Cl. CPC H04L 5/006; H04B 7/06952; H04L 5/0051; H04L 5/0091

(57) ABSTRACT

A method of wireless communication at a UE is disclosed herein. The method includes receiving a configuration for reporting at least one L1 signal quality measurement for at least one SSB or at least one CSI-RS associated with a first cell. The method includes transmitting, based on the configuration, the at least one L1 signal quality measurement for the at least one SSB or the at least one CSI-RS associated with the first cell. The method includes receiving, based on the at least one L1 signal quality measurement, data or at least one signal via at least one DL beam associated with a SCell, where the SCell is not associated with a transmission of a corresponding SSB, where the first cell and the SCell are associated with different frequency bands.

### CROSS-REFERENCE TO RELATED APPLICATION

This application claims the benefit of Greece Patent Application Serial No. 20220100865, entitled “RSRP REPORTING FOR BEAM MANAGEMENT IN INTER-BAND SSB-LESS SCELL” and filed on Oct. 21, 2022, which is expressly incorporated by reference herein in its entirety.

### TECHNICAL FIELD

The present disclosure relates generally to communication systems, and more particularly, to a beam management (BM).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus includes a memory and at least one processor coupled to the memory and, based at least in part on information stored in the memory, the at least one processor is configured to: receive a configuration for reporting at least one layer 1 (L1) signal quality measurement for at least one synchronization signal block (SSB) or at least one channel-state information reference signal (CSI-RS) associated with a first cell; transmit, based on the configuration, the at least one L1 signal quality measurement for the at least one SSB or the at least one CSI-RS associated with the first cell; and receive, based on the at least one L1 signal quality measurement, data or at least one signal via at least one downlink (DL) beam associated with a secondary cell (SCell), where the SCell is not associated with a transmission of a corresponding SSB, where the first cell and the SCell are associated with different frequency bands.

In an aspect of the disclosure, a method, a computer-readable medium, and an apparatus for wireless communication at a network entity are provided. The apparatus includes a memory and at least one processor coupled to the memory and, based at least in part on information stored in the memory, the at least one processor is configured to: transmit, for a user equipment (UE), a configuration for reporting at least one layer 1 (L1) signal quality measurement for at least one synchronization signal block (SSB) or at least one channel-state information reference signal (CSI-RS) associated with a first cell; receive, based on the configuration, the at least one L1 signal quality measurement for the at least one SSB or the at least one CSI-RS associated with the first cell; and transmit, based on the at least one L1 signal quality measurement, data or at least one signal for the UE via at least one downlink (DL) beam associated with a secondary cell (SCell), where the SCell is not associated with a transmission of a corresponding SSB, where the first cell and the SCell are associated with different frequency bands.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an example of an artificial intelligence (AI)/machine learning (ML) algorithm that may be used in connection with wireless communication.

FIG. 5 is a diagram illustrating example aspects of beamforming.

FIG. 6 is a diagram illustrating examples of a procedure 1 (P1) beam refinement procedure, a procedure 2 (P2) beam refinement procedure, and a procedure 3 (P3) beam refinement procedure.

FIG. 7 is a diagram illustrating example aspects of beam squinting.

FIG. 8 is a diagram illustrating example aspects of DL beam determination on a SSB-less secondary cell (SCell).

FIG. 9 is a diagram illustrating example mapping functions between reference signal received power (RSRP) measurements for a synchronization signal block (SSB) or a channel-state information reference signal (CSI-RS) and a DL beam for a SSB-less SCell.

FIG. 10 is a diagram illustrating an example of determining a DL beam for a SSB-less SCell.

FIG. 11 is a diagram illustrating an example of a mapping function training procedure.

FIG. 12 is a diagram illustrating an example of a two-phase mapping function training.

FIG. 13 is a diagram illustrating example communications between a UE and a base station.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus.

FIG. 19 is a diagram illustrating an example of a hardware implementation for an example network entity.

### DETAILED DESCRIPTION

A SCell may be configured without a corresponding SSB (“a SSB-less SCell”) in order to provide for reduced energy consumption in a wireless communication system that supports multi-carrier operation. A UE may not be able to perform a L1-RSRP measurement on a SSB-less SCell (e.g., an inter-band SSB-less SCell) as the SSB-less SCell may not have a SSB to measure. As such, the UE may not be able to report information pertaining to DL beam management for the SSB-less SCell to a base station associated with the SSB-less SCell. This may impact an ability of the UE and the base station to engage in beam management procedures with respect to the SSB-less SCell. Additionally, a DL beam of an anchor cell (e.g., a primary cell (PCell) or another SCell) associated with the base station may not be well-aligned with a DL beam associated with the SSB-less SCell if there is a relatively large carrier frequency separation (i.e., “beam squinting”) between a carrier of the anchor cell and a carrier of the SSB-less SCell. Various technologies pertaining to beam management for a SSB-less SCell are described herein. In an example, a UE receives a configuration for reporting at least one L1 signal quality measurement for at least one SSB or at least one CSI-RS associated with a first cell. The UE transmits, based on the configuration, the at least one L1 signal quality measurement for the at least one SSB or the at least one CSI-RS associated with the first cell. The UE receives, based on the at least one L1 signal quality measurement, data or at least one signal via at least one DL beam associated with a SCell, where the SCell is not associated with a transmission of a corresponding SSB, where the first cell and the SCell are associated with different frequency bands. The L1 signal quality measurement(s) performed on the SSBs/CSI-RSs associated with the first cell may be utilized as a proxy for beam management purposes to select a DL beam associated with the SCell (i.e., a SSB-less SCell). Thus, the above-described technologies may be associated with increased communications reliability over SSB-less SCells by mitigating the effects of beam squinting. Additionally, the above-described technologies may facilitate beam management when a SCell is not associated with a SSB/CSI-RS transmission.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

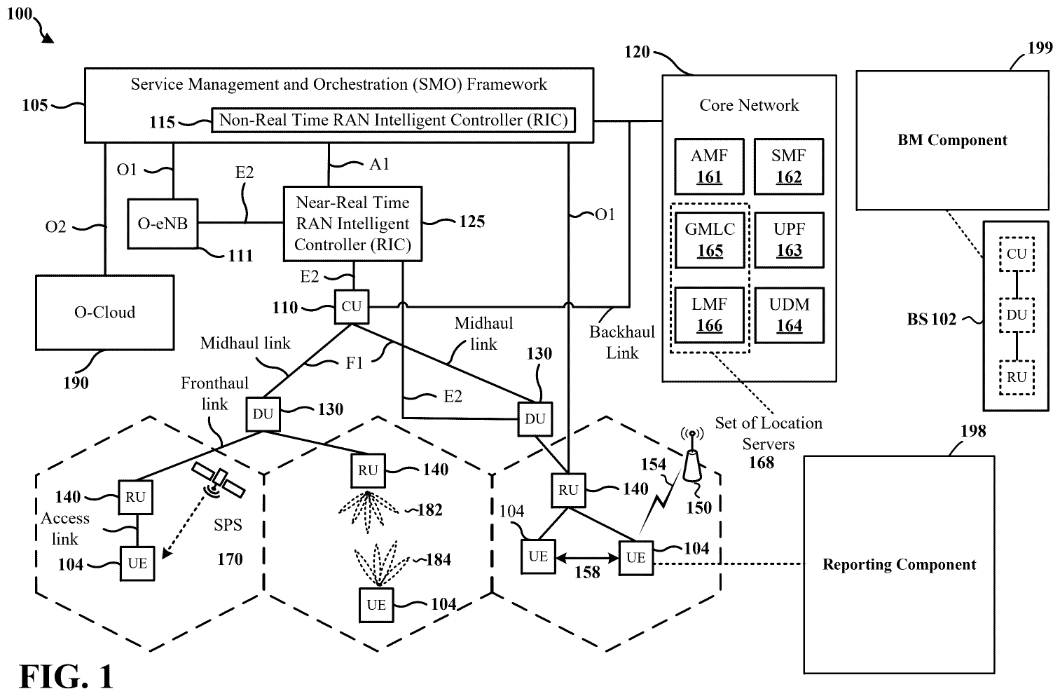

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit User Plane (CU-UP)), control plane functionality (i.e., Central Unit Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be including a reporting component 198 that is configured to receive a configuration for reporting at least one L1 signal quality measurement for at least one SSB or at least one CSI-RS associated with a first cell; transmit, based on the configuration, the at least one L1 signal quality measurement for the at least one SSB or the at least one CSI-RS associated with the first cell; and receive, based on the at least one L1 signal quality measurement, data or at least one signal via at least one DL beam associated with a SCell, where the SCell is not associated with a transmission of a corresponding SSB, where the first cell and the SCell are associated with different frequency bands. In certain aspects, the base station 102 may include a BM component 199 that is configured to transmit, for a UE, a configuration for reporting at least one L1 signal quality measurement for at least one SSB or at least one CSI-RS associated with a first cell; receive, based on the configuration, the at least one L1 signal quality measurement for the at least one SSB or the at least one CSI-RS associated with the first cell; and transmit, based on the at least one L1 signal quality measurement, data or at least one signal for the UE via at least one DL beam associated with a SCell, where the SCell is not associated with a transmission of a corresponding SSB, where the first cell and the SCell are associated with different frequency bands. Although the following description may be focused on a layer 1 (L1) RSRP measurements, the concepts described herein may be applicable to other signal quality measurements as well. Although the following description may be focused on 5G NR, the concepts described herein may be applicable to other similar areas, such as LTE, LTE-A, CDMA, GSM, and other wireless technologies.

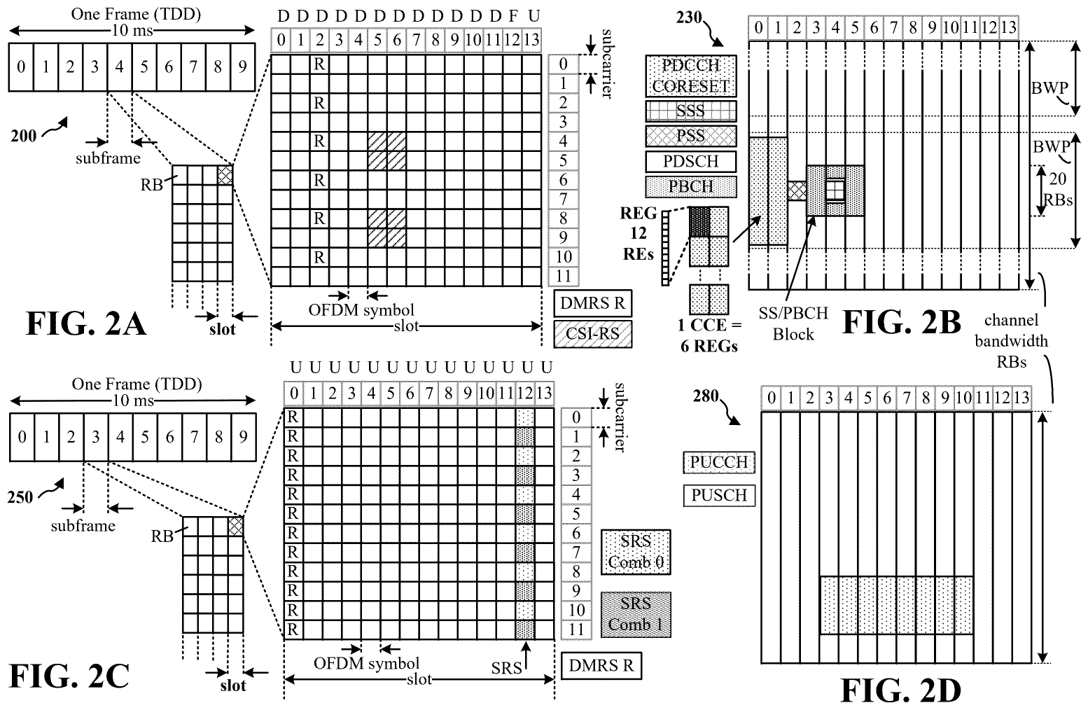

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

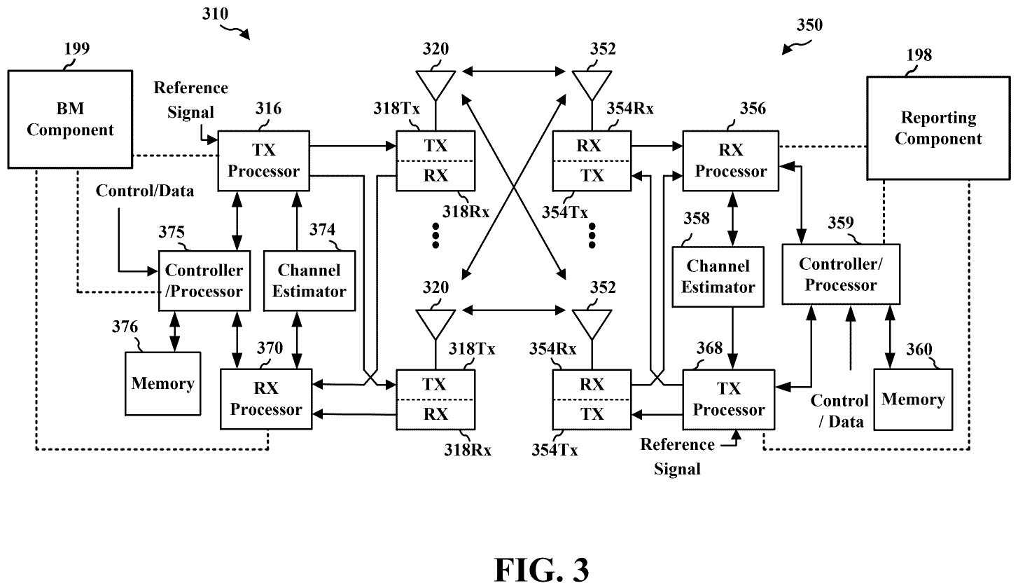

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reporting component 198 of FIG. 1.

At least one of the TX processor 316, the RX processor 370, and the controller/processor 375 may be configured to perform aspects in connection with the BM component 199 of FIG. 1.

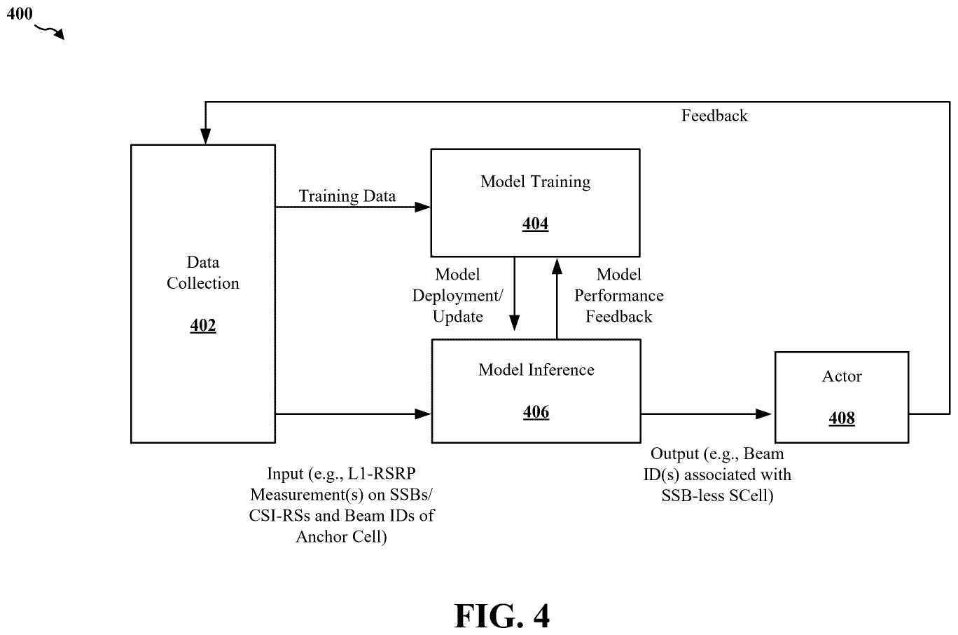

FIG. 4 is an example of a AI/ML algorithm 400 that may be used in connection with wireless communication. The AI/ML algorithm 400 may include various functions including a data collection 402, a model training function 404, a model inference function 406, and an actor 408.

The data collection 402 may be a function that provides input data to the model training function 404 and the model inference function 406. The data collection 402 function may include any form of data preparation, and it may not be specific to the implementation of the AI/ML algorithm (e.g., data pre-processing and cleaning, formatting, and transformation). Examples of input data may include, but may not be limited to, L1-RSRP measurements performed on SSBs/CSI-RSs associated with an anchor cell, identifiers for the SSBs/CSI-RSs or identifiers for DL beams on which the SSBs/CSI-RSs are transmitted, L1-RSRP measurements performed on candidate SSBs/CSI-RSs associated with a SSB-less SCell, and identifiers for the candidate SSBs/CSI-RSs or identifiers for DL beams on which the candidate SSBs/CSI-RSs are transmitted, from UEs or network nodes, feedback from the actor 408, output from another AI/ML model. The data collection 402 may include training data, which refers to the data to be sent as the input for the model training function 404, and inference data, which refers to be sent as the input for the model inference function 406.

The model training function 404 may be a function that performs the ML model training, validation, and testing, which may generate model performance metrics as part of the model testing procedure. The model training function 404 may also be responsible for data preparation (e.g., data pre-processing and cleaning, formatting, and transformation) based on the training data delivered or received from the data collection 402 function. The model training function 404 may deploy or update a trained, validated, and tested AI/ML model to the model inference function 406, and receive a model performance feedback from the model inference function 406.

The model inference function 406 may be a function that provides the AI/ML model inference output (e.g., predictions or decisions). The model inference function 406 may also perform data preparation (e.g., data pre-processing and cleaning, formatting, and transformation) based on the inference data delivered from the data collection 402 function. The output of the model inference function 406 may include the inference output of the AI/ML model produced by the model inference function 406. The details of the inference output may be use-case specific. As an example, the output may include an identifier for at least one DL beam associated with a SSB-less SCell. In some aspects, the actor 408 may be a UE or a network node at the UE.

The model performance feedback may refer to information derived from the model inference function 406 that may be suitable for improvement of the AI/ML model trained in the model training function 404. The feedback from the actor 408 or other network entities (via the data collection 402 function) may be implemented for the model inference function 406 to create the model performance feedback.

The actor 408 may be a function that receives the output from the model inference function 406 and triggers or performs corresponding actions. The actor may trigger actions directed to network entities including the other network entities or itself. The actor 408 may also provide a feedback information that the model training function 404 or the model inference function 406 to derive training or inference data or performance feedback. The feedback may be transmitted back to the data collection 402.

The network may use machine-learning algorithms, deep-learning algorithms, neural networks, reinforcement learning, regression, boosting, or advanced signal processing methods for aspects of wireless communication including the identification of a DL beam associated with a SSB-less SCell.

In some aspects described herein, the network may train one or more neural networks to learn dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks (BNs); genetic algorithms; deep convolutional networks (DCNs) configured with additional pooling and normalization layers; and deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

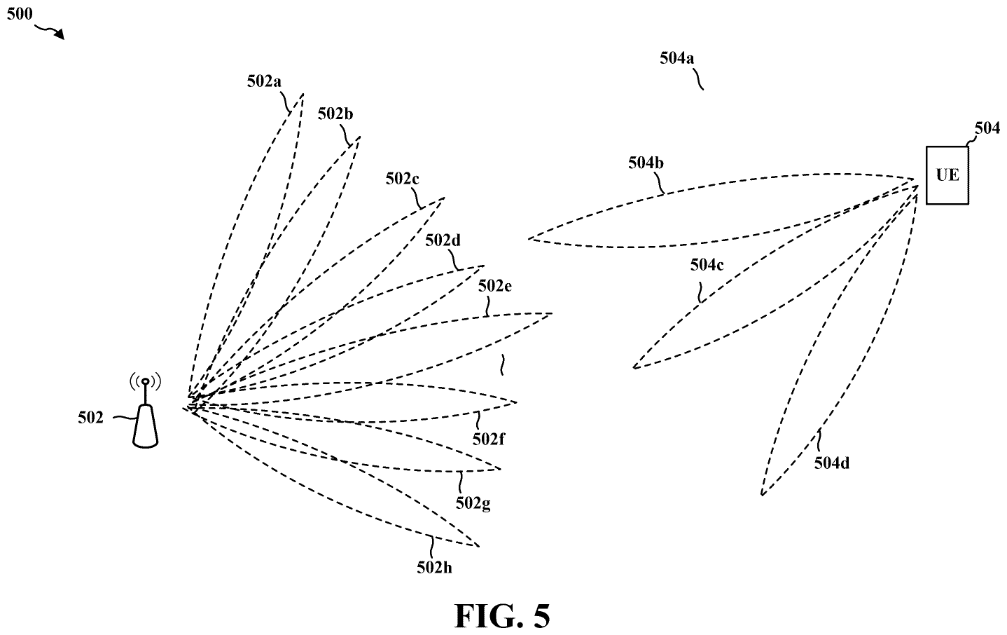

FIG. 5 is a diagram 500 illustrating example aspects of beamforming. As described in connection with the diagram 500 in FIG. 5, a base station 502 and UE 504 may communicate over active data/control beams both for DL communication and UL communication. The base station and/or UE may switch to a new beam direction using beam failure recovery procedures. Referring to FIG. 5, the base station 502 may transmit a beamformed signal to the UE 504 in one or more of the directions 502a, 502b, 502c, 502d, 502e, 502f, 502g, 502h. The UE 504 may receive the beamformed signal from the base station 502 in one or more receive directions 504a, 504b, 504c, 504d. The UE 504 may also transmit a beamformed signal to the base station 502 in one or more of the directions 504a-504d. The base station 502 may receive the beamformed signal from the UE 504 in one or more of the receive directions 502a-502h. The base station 502/UE 504 may perform beam training to determine the best receive and transmit directions for each of the base station 502/UE 504. The transmit and receive directions for the base station 502 may or may not be the same. The transmit and receive directions for the UE 504 may or may not be the same.

In response to different conditions, the UE 504 may determine to switch beams, e.g., between beams 502a-502h. The beam at the UE 504 may be used for reception of downlink communication and/or transmission of uplink communication. In some examples, the base station 502 may send a transmission that triggers a beam switch by the UE 504. For example, the base station 502 may indicate a transmission configuration indication (TCI) state change, and in response, the UE 504 may switch to a new beam for the new TCI state of the base station 502. In some instances, a UE may receive a signal, from a base station, configured to trigger a transmission configuration indication (TCI) state change via, for example, a MAC control element (CE) command. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. In some aspects, a single MAC-CE command may be sent by the base station to trigger the changing of the TCI state on multiple CCs.

A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

Before receiving a TCI state, a UE may assume that the antenna ports of one DM-RS port group of a PDSCH are spatially quasi-co-located (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam).

In another aspect, a spatial relation change, such as a spatial relation update, may trigger the UE to switch beams. Beamforming may be applied to uplink channels, such as but not limited to PUCCH. Beamforming may be based on configuring one or more spatial relations between the uplink and downlink signals. Spatial relation indicates that a UE may transmit the uplink signal using the same beam as it used for receiving the corresponding downlink signal.

In another aspect, the base station 502 may change a pathloss reference signal configuration that the UE uses to determine power control for uplink transmissions, such as SRS, PUCCH, and/or PUSCH. In response to the change in the pathloss reference signal, the UE 504 may determine to switch to a new beam.

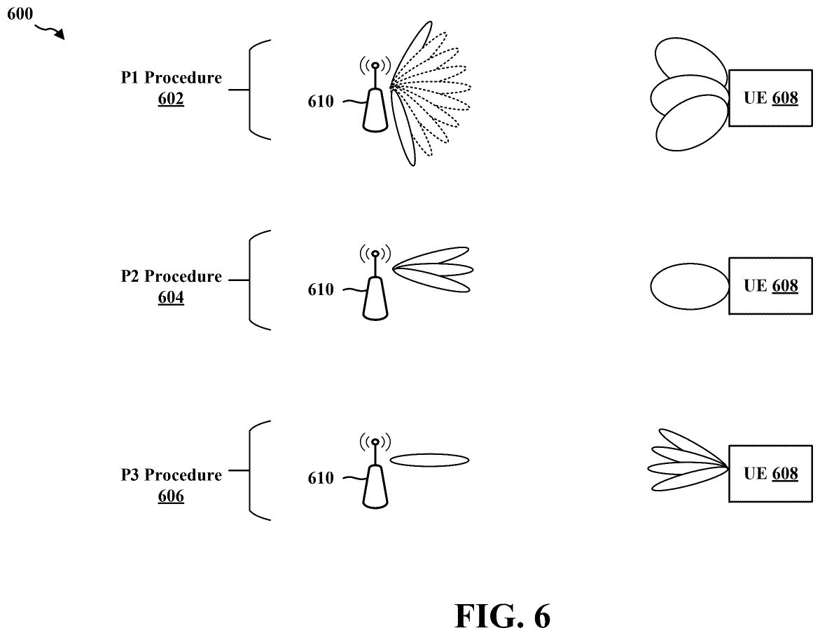

FIG. 6 is a diagram 600 illustrating examples of a P1 beam refinement procedure 602, a P2 beam refinement procedure 604, and a P3 beam refinement procedure 606. In general, the P1 beam refinement procedure 602, the P2 beam refinement procedure 604, and the P3 beam refinement procedure 606 may facilitate beam management while a UE 608 is in a connected state with a base station 610 (e.g., a gNB). The P1 beam refinement procedure 602, the P2 beam refinement procedure 604, and the P3 beam refinement procedure 606 may be related to DL beam management. The P1 beam refinement procedure 602, the P2 beam refinement procedure 604, and the P3 beam refinement procedure 606 may be respectively referred to as a P1 procedure, a P2 procedure, and a P3 procedure.

In general, the P1 beam refinement procedure 602 may relate to beam selection. The P1 beam refinement procedure 602 may enable the UE 608 to measure different Tx beams of the base station 610 (illustrated as ovals in the diagram 600) to support a selection of one or more of the Tx beams of the base station 610 and/or one or more Rx beams of the UE 608. For beamforming at the UE 608, the P1 beam refinement procedure 602 may include a UE Rx beam sweep from a set of different beams. The P1 beam refinement procedure 602 may involve selecting a SSB having a strongest RSRP measurement (e.g., a L1-RSRP measurement), where the SSB may be associated with a Tx beam and/or a Rx beam. The UE 608 and the base station 610 may track RSRP measurements via RSRP reporting by the UE 608 to the base station 610.

In general, the P2 beam refinement procedure 604 may relate to beam refinement for a transmitter (e.g., the base station 610). The P2 beam refinement procedure 604 may be used to enable UE measurement on different TRP Tx beams in order to potentially change one or more inter/intra-TRP Tx beams. A smaller set of beams may be utilized in the P2 beam refinement procedure 604 compared to a set of beams utilized in the P1 beam refinement procedure 602. The P2 beam refinement procedure 604 may involve aperiodic CSI-RS/SSB measurements that are communicated via DCI. In an example, the base station 610 may sweep CSI-RSs through a set of candidate beams. The UE 608 may measure a strongest CSI-RS RSRP measurement (e.g., a L1-RSRP measurement). The UE 608 may report the strongest CSI-RS RSRP measurement (from amongst many CSI-RS RSRP measurements) to the base station 610. The base station 610 may fix a beam based on the strongest CSI-RS RSRP measurement.

In general, the P3 beam refinement procedure 606 may relate to beam refinement at a receiver (e.g., the UE 608). The P3 beam refinement procedure 606 may enable the UE 608 to measure a Tx beam of the base station 610 in order for the UE 608 to change a Rx beam if the UE 608 is configured with beamforming functionality. The P3 beam refinement procedure 606 may establish an optimal UE Rx beam using aperiodic CSI-RSs. The P3 beam refinement procedure 606 may involve the base station 610 fixing a Tx beam and indicating QCL information to the UE 608. CSI-RS resources in a slot may have a same beam configuration on the base station 610. The UE 608 may perform RSRP measurements (e.g., L1-RSRP measurements) on CSI-RSs and the UE 608 may select an optimal Rx beam based on the RSRP measurements.

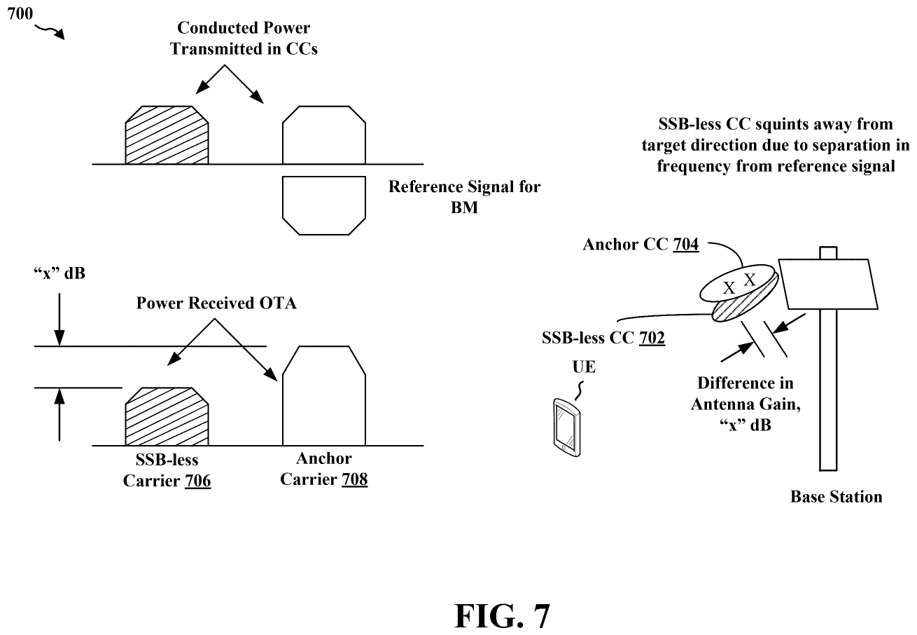

FIG. 7 is diagram 700 illustrating example aspects of beam squinting. Beam squinting may refer to a phenomenon that occurs when hardware (e.g., antennas, phase shifters, etc.) that are used for a carrier frequency f₀ are used for another frequency f₁, where f₁ may be largely separated in frequency from f₀. Beam squinting may result in two different TCI states at an anchor carrier and a SSB-less carrier associated with a SCell. Beam squinting may cause a transmitted beam associated with a SSB-less SCell to diverge by a relatively large angle from a transmitted beam associated with an anchor cell. The divergence may result in propagation profiles being different for the anchor cell and the SSB-less SCell. In one aspect, a shape of a transmitted beam (e.g., a DL beam) may be based on an antenna configuration of a base station (e.g., a gNB) and a carrier frequency of a signal.

As illustrated in the diagram 700, a SSB-less component carrier (CC) 702 may “squint” away from a target direction due to a separation in frequency from a reference signal associated with an anchor cell CC 704. Furthermore, the separation in frequency may result in a beam associated with the SSB-less CC 702 to have different characteristics (e.g., shape) than a beam associated with the anchor cell CC 704. The squinting may be associated with a difference in antenna gain (e.g., ‘x’ dB). Additionally, beam squinting may cause a UE to obtain different signal quality measurements (e.g., L1-RSRP measurements) for the same reference signal transmitted over the SSB-less CC 702 and the anchor cell CC 704.

As illustrated in the diagram 700, a SSB-less carrier 706 may be associated with a first frequency (e.g., 2.5 GHz) and an anchor carrier 708 may be associated with a second frequency (e.g., 700 MHz). In an example, a base station may transmit a reference signal for beam management (BM) in the SSB-less carrier 706 and the anchor carrier 708. The transmitted reference signal may have the same (or a similar) conducted power for the SSB-less carrier 706 and the anchor carrier 708. However, due to the difference between the first frequency and the second frequency, a first signal quality measurement performed by a UE on the reference signal carried by the SSB-less carrier 706 may differ from a second signal quality measurement performed by the UE on the reference signal carried by the anchor carrier 708. Stated differently, power received over the air (OTA) may differ. The difference in the power received OTA may impact an ability of the base station to control shapes of beams associated with the SSB-less carrier 706.

A SCell may be configured without a corresponding SSB (“a SSB-less SCell”) in order to provide for reduced energy consumption in a wireless communication system that supports multi-carrier operation. A UE may not be able to perform a L1-RSRP measurement on a SSB-less SCell (e.g., an inter-band SSB-less SCell) as the SSB-less SCell may not have a SSB to measure. As such, the UE may not be able to report information pertaining to DL beam management for the SSB-less SCell to a base station associated with the SSB-less SCell. Additionally, a DL beam of an anchor cell (e.g., a PCell or another SCell) associated with the base station may not be well-aligned with a DL beam associated with the SSB-less SCell when there is a relatively large carrier frequency separation (i.e., “beam squinting”) between a carrier of the anchor cell and a carrier of the SSB-less SCell.

Various technologies pertaining to beam management for a SSB-less SCell are described herein. In an example, a UE receives a configuration for reporting at least one L1 signal quality measurement for at least one SSB or at least one CSI-RS associated with a first cell. The UE transmits, based on the configuration, the at least one L1 signal quality measurement for the at least one SSB or the at least one CSI-RS associated with the first cell. The UE receives, based on the at least one L1 signal quality measurement, data or at least one signal via at least one DL beam associated with a SCell, where the SCell is not associated with a transmission of a corresponding SSB, where the first cell and the SCell are associated with different frequency bands. The L1 signal quality measurement(s) performed on the SSBs/CSI-RSs associated with the first cell may be utilized as a proxy for beam management purposes to select a DL beam associated with the SCell (i.e., a SSB-less SCell). Thus, the above-described technologies may be associated with increased communications reliability over SSB-less SCells by mitigating the effects of beam squinting. Additionally, the above-described technologies may facilitate beam management when a SCell is not associated with a SSB/CSI-RS transmission.

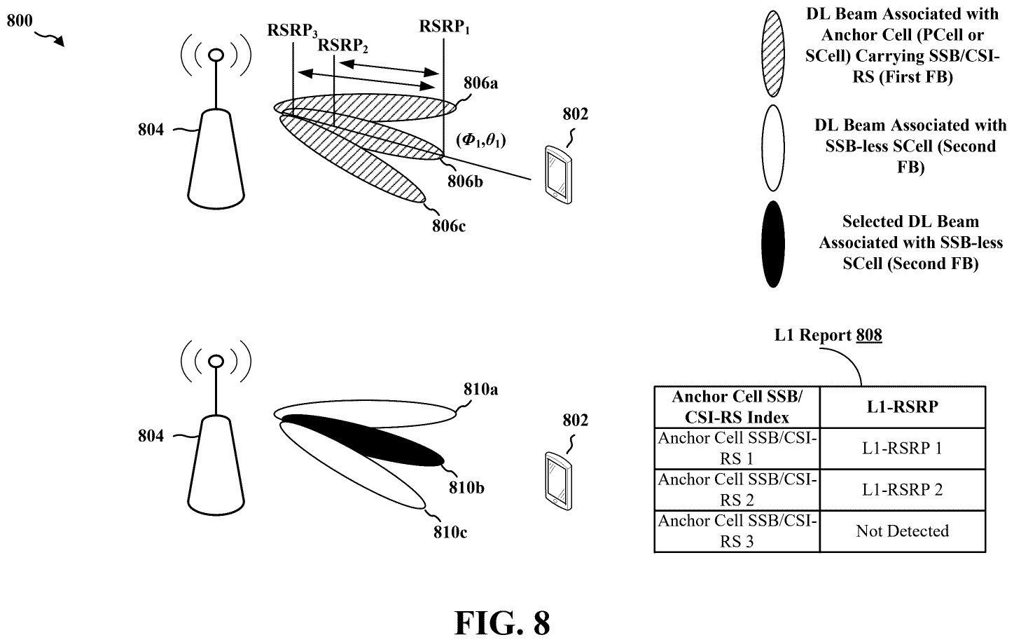

FIG. 8 is a diagram 800 illustrating example aspects of DL beam determination on a SSB-less SCell. As will be described in greater detail below, a base station 804 (e.g., a gNB) may utilize L1-RSRP reporting on multiple SSBs and/or CSI-RSs on an anchor cell to determine a DL beam for transmitting data/signals for a SSB-less SCell. The anchor cell may be a PCell or the anchor cell may be a second SCell that is associated with a transmission of a SSB or a CSI-RS. The SSB-less SCell may be a SCell that is not associated with a transmission of a SSB. The anchor cell may be associated with a first frequency band (FB) and the SSB-less SCell may be associated with a second FB, where the first FB may be different from the second FB.

As illustrated in the diagram 800, the base station 804 may transmit SSBs and/or CSI-RSs via DL beams associated with the anchor cell. In an example, the DL beams associated with the anchor cell may include a first DL beam 806a, a second DL beam 806b, and a third DL beam 806c. In the example, the first DL beam 806a may be associated with a first SSB or a first CSI-RS (or a first SSB index or a first CSI-RS index) of the anchor cell, the second DL beam 806b may be associated with a second SSB or a second CSI-RS (or a second SSB index or a second CSI-RS index) of the anchor cell, and the third DL beam 806c may be associated with a third SSB or a third CSI-RS (or a third SSB index or a third CSI-RS index) of the anchor cell.

The base station 804 may configure a UE 802 to perform L1-RSRP measurements (or another signal quality measurement) on K SSBs and/or CSI-RSs associated with the anchor cell, where K is a positive integer. In an example, K may be three. In one aspect, K may be one if a spatial beam shape is identical or within a threshold difference between the anchor cell and the SSB-less SCell. The UE 802 may perform an L1-RSRP measurement on respective SSBs/CSI-RSs of each of the first DL beam 806a, the second DL beam 806b, and the third DL beam 806c. Stated differently, the UE 802 may perform the L1-RSRP measurements to obtain a first L1-RSRP measurement, a second L1-RSRP measurement, and a third L1-RSRP measurement.

In one aspect, for each SSB/CSI-RS index n, the base station 804 may configure the UE 802 to measure and report a group of K SSBs/CSI-RSs together. The UE 802 may measure and report L1-RSRP measurements for K SSBs/CSI-RSs associated with a SSB/CSI-RS with a greatest (i.e., strongest) L1-RSRP measurement.

In one aspect, the base station 804 may configure the UE 802 to perform L1-RSRP measurements on SSBs/CSI-RSs associated with the anchor cell. The base station 804 may also configure the UE 802 to report a greatest (i.e., strongest) L1-RSRP measurement and a number of additional L1-RSRP measurements that are associated with the greatest L1-RSRP measurement (e.g., a second strongest L1-RSRP measurement, a third strongest L1-RSRP measurement, etc.)

The UE 802 may transmit the L1-RSRP measurements and indications of respective SSBs and/or CSI-RSs associated with the L1-RSRP measurements to the base station 804. In an example, the UE 802 may transmit a L1 report 808 to the base station 804. The L1 report 808 may include an indication of a SSB/CSI-RS associated with the anchor cell and a corresponding L1-RSRP measurement performed by the UE 802 for the SSB/CSI-RS. In one aspect, the L1 report 808 may report “Not Detected” for SSBs/CSI-RSs that the UE 802 could not detect/measure.

The base station 804 may determine (i.e., select) a DL beam from a set of DL beams associated with the SSB-less SCell cell based on the L1-RSRP measurements and indications of their respective SSBs and/or CSI-RSs of the anchor cell and a mapping function. In one aspect, the base station 804 may determine/select the DL beam based on the L1 report 808. In an example, the mapping function may be a look-up table or a non-linear function such as a neural network. In one aspect, the mapping function may map K L1-RSRP measurements associated with respective SSBs/CSI-RSs of the anchor cell to DL beams associated with the SSB-less SCell. Example mapping functions are described in greater detail below.

In an example, the set of DL beams associated with the SSB-less SCell may include a first DL beam 810a, a second DL beam 810b, and a third DL beam 810c. In an example, the base station 804 may select the second DL beam 810b based on the L1-RSRP measurements and indications of their respective SSBs and/or CSI-RSs associated with the anchor cell and the mapping function. After selecting the second DL beam 810b, the base station 804 may transmit data/signal(s) to the UE 802 via the second DL beam 810b. In an example, the second DL beam 810b may be associated with a higher communications reliability for DL transmission in comparison to the first DL beam 810a and the third DL beam 810c.

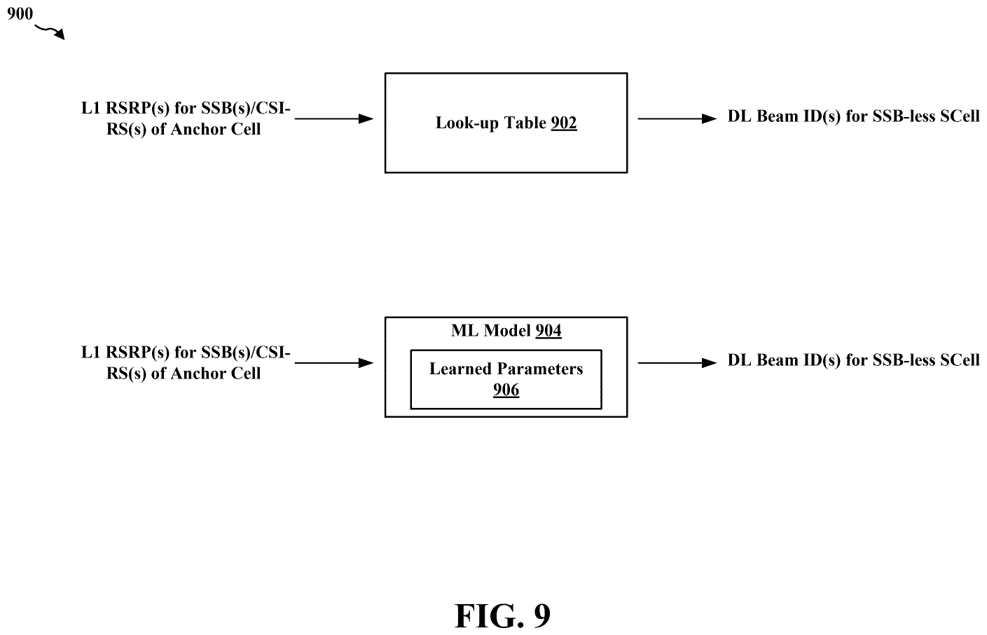

FIG. 9 is a diagram 900 illustrating example mapping functions between L1-RSRP measurements for a SSB or a CSI-RS and a DL beam for a SSB-less SCell. In one aspect, a mapping function utilized by a base station (e.g., the base station 804) may be a look-up table 902. In an example, the look-up table 902 may include entries that indicate a DL beam (or DL beams) associated with the SSB-less SCell given a L1-RSRP measurement (or L1-RSRP measurements) for a particular SSB/CSI-RS (or SSBs/CSI-RSs) associated with an anchor cell. For instance, the look-up table 902 may include an entry that indicates that if K L1-RSRP measurements performed on SSBs/CSI-RSs associated with the anchor cell are first K values, a first DL beam associated with the SSB-less SCell is to be utilized for DL transmissions and if the K L1-RSRP measurements performed on the SSBs/CSI-RSs associated with the anchor are second K values, a second DL beam associated with the SSB-less SCell is to be utilized for the DL transmissions. In one aspect, the look-up table 902 may include an entry that indicates that if K L1-RSRP measurements performed on SSBs/CSI-RSs associated with the anchor cell fall within first K ranges of values, the first DL beam associated with the SSB-less SCell is to be utilized for DL transmissions and that if the K L1-RSRP measurements performed on the SSBs/CSI-RSs associated with the anchor cell fall within second Kranges of values, the second DL beam associated with the SSB-less SCell is to be utilized for DL transmissions. In one aspect, the look-up table 902 may include an entry that indicates that a DL beam associated with the SSB-less SCell cannot be identified based on a given L1-RSRP measurement (or given L1-RSRP measurements). In an example, the look-up table 902 may be generated based on a cross-band beam calibration procedure, a private measurement campaign, or one or more P2 procedures (e.g., the P2 beam refinement procedure 604).

In an example, the base station may receive L1-RSRP measurement(s) performed on SSB(s)/CSI-RS(s) associated with the anchor cell from a UE (e.g., the UE 802) and indications of the respective SSB(s)/CSI-RS(s). Based on the L1-RSRP measurement(s), the indications, and the look-up table 902, the base station may identify a DL beam (or DL beams) associated with the SSB-less SCell. The base station may transmit data/signals to the UE via the DL beam (or DL beams) associated with the SSB-less SCell.

In one aspect, the mapping function utilized by the base station may be a ML model 904 that includes learned parameters 906 that are generated by way of a training process of the ML model 904. In an example, the ML model 904 may be a neural network and the learned parameters 906 may be weights of the neural network. In an example, the ML model 904 may be trained using one or more aspects described above in connection with FIG. 4. In an example, the ML model 904 may be trained based on a cross-band beam calibration procedure, a private measurement campaign, or one or more P2 procedures (e.g., the P2 beam refinement procedure 604).

In an example, the base station may receive L1-RSRP measurement(s) performed on SSB(s)/CSI-RS(s) associated with the anchor cell from a UE (e.g., the UE 802) and indications of the respective SSB(s)/CSI-RS(s). The base station may provide the L1-RSRP measurement(s) and the indications as input to the ML model 904. Based on the input and the learned parameters 906, the base station may obtain a value (or values) as an output of the ML model 904. The value (or values) may be indicative of a DL beam (or DL beams) associated with the SSB-less SCell. In one aspect, a particular value (or particular values) output by the ML model 904 may indicate that a DL beam associated with the SCell cannot be identified. The base station may transmit data/signals to the UE via the DL beam (or DL beams) associated with the SSB-less SCell.

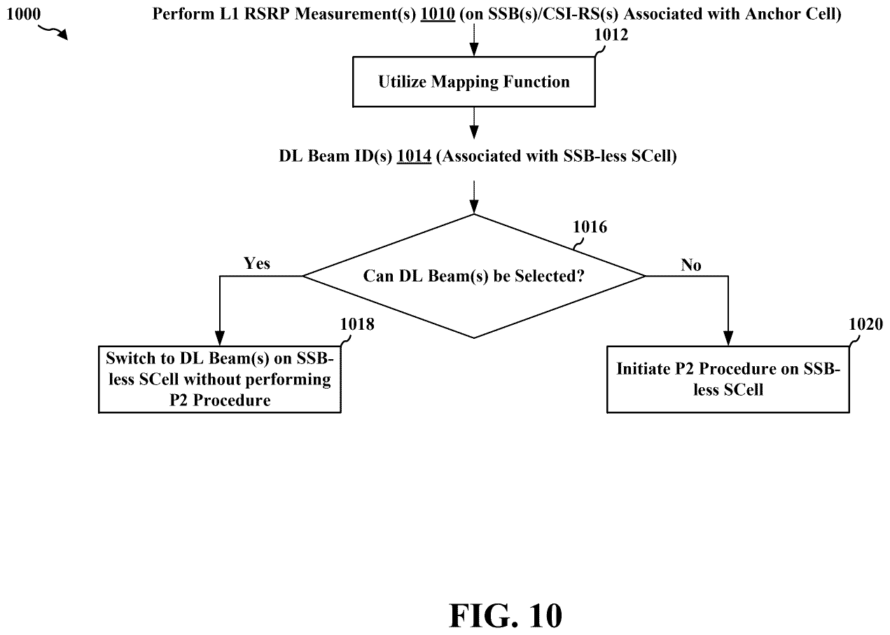

FIG. 10 is a diagram 1000 illustrating an example of determining a DL beam for a SSB-less SCell. At 1010, a base station (e.g., the base station 804) may perform L1-RSRP measurement(s) on SSB(s)/CSI-RS(s) associated with an anchor cell (e.g., as described above in the description of FIG. 8). At 1012, the base station may utilize a mapping function in conjunction with the L1-RSRP measurement(s) to identify DL beam identifiers (IDs) 1014 associated with a SSB-less SCell. In an example, the mapping function may be or include the look-up table 902 or the ML model 904.

At 1016, the base station may determine whether a DL beam (or DL beams) associated with the SSB-less SCell may be selected based on criteria. Stated differently, the base station may determine whether a “best” DL beam (or DL beams) may be selected based on K L1-RSRP measurements and the criteria. In an example, the criteria may be that the mapping function outputs a single DL beam ID associated with the SSB-less SCell. In another example, the criteria may be that the mapping function outputs a certain number of DL beam IDs (e.g., three) associated with the SSB-less SCell. In yet another example, the mapping function may output a confidence value for each DL beam ID associated with the SSB-less SCell. The confidence value may be based on communication reliability metrics of other UEs when the UEs utilized a DL beam (or a similar DL beam) associated with the DL beam ID for receiving DL transmissions. The base station may determine whether the DL beam (or DL beams) associated with the SSB-less SCell may be selected based on the confidence value(s) and threshold value(s). For example, if the confidence value is greater than or equal to the threshold value, the base station may determine that a DL beam associated with the SSB-less SCell may be selected. If the confidence value is less than a threshold value, the base station may determine that the DL beam associated with the SSB-less SCell may not be selected.

At 1018, upon positive determination, the base station may switch to the DL beam (or DL beams) identified by the mapping function for DL transmissions via the SSB-less SCell without performing a P2 procedure (e.g., the P2 beam refinement procedure 604) on the SSB-less SCell. The base station may indicate the switch (i.e., a switch event) to the UE via a MAC control element (MAC-CE) or a DCI. The MAC-CE or the DCI may trigger the UE to reset one or more loop filters. The loop filters may include an automatic gain control (AGC) loop, a time tracking loop (TTL), or a frequency tracking loop (FTL).

At 1020, upon negative determination, the base station may initiate a P2 procedure (e.g., the P2 beam refinement procedure 604) on the SSB-less SCell to determine a DL beam (or DL beams) associated with the SSB-less SCell that is/are to be used for DL transmissions. In an example, the base station may identify (i.e., determine) M candidate beam(s) associated with the SSB-less SCell using the mapping function, where M is a positive integer. The base station may cause SSB(s)/CSI-RS(s) to be transmitted via the candidate beam(s) associated with the SSB-less SCell as part of the P2 procedure. In an example, the SSB(s)/CSI-RS(s) may be transmitted via the candidate beam(s) associated with the SSB-less SCell during the P2 procedure and the SSB(s)/CSI-RS(s) may not be transmitted via the candidate beam(s) during regular operation of the base station. The UE may measure and report L1-RSRP measurements for SSB(s)/CSI-RS(s) of the candidate beams. In one aspect, the UE may report L L1-RSRP measurements for the candidate beams, where L is a positive integer that is less than M. The base station may identify/determine a DL beam (or DL beams) associated with the SSB-less SCell based on the L1-RSRP measurements performed on the SSB(s)/CSI-RS(s) of the candidate beams. The base station may transmit a TCI state update to the UE based on the identified DL beam (or DL beams).

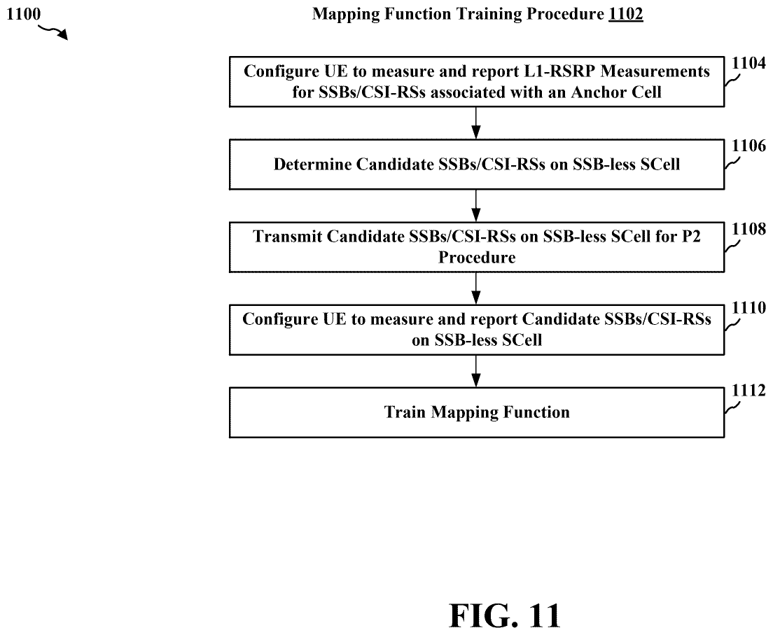

FIG. 11 is a diagram 1100 illustrating an example of a mapping function training procedure 1102. The mapping function training procedure 1102 may be associated with a P2 procedure (e.g., the P2 beam refinement procedure 604) on a SSB-less SCell. The mapping function training procedure 1102 may be used to construct a mapping function. For instance, the mapping function training procedure 1102 may be used to generate the look-up table 902 and/or train the ML model 904.

At 1104, a base station (e.g., the base station 804) may configure a UE (e.g., the UE 802) to measure and report L1-RSRP measurements for SSBs/CSI-RSs associated with an anchor cell. For instance, for each SSB/CSI-RS index n, the base station may configure a group of K SSBs/CSI-RSs to be measured and reported on the anchor cell. In one aspect, the base station may configure the UE to measure and report L1-RSRP measurements for SSBs/CSI-RSs associated with a greatest (i.e., strongest) L1-RSRP measurement for a SSB/CSI-RS associated with the anchor cell.

At 1106, the base station may determine candidate SSBs/CSI-RSs on a SSB-less SCell based on the L1-RSRP measurements for SSBs/CSI-RSs associated with the anchor cell. For instance, based on the L1-RSRP measurements for the K SSBs/CSI-RSs on the anchor cell, the base station may determine/identify M candidate SSBs/CSI-RSs for the SSB-less SCell. In an example, the candidate SSB(s)/CSI-RS(s) may be transmitted via candidate beam(s) associated with the SSB-less SCell during the P2 procedure and the candidate SSB(s)/CSI-RS(s) may not be transmitted via the candidate beam(s) during regular operation of the base station.

At 1108, the base station may transmit the candidate SSB(s)/CSI-RS(s) via candidate beam(s) associated with the SSB-less SCell as part of the P2 procedure. At 1110, the base station may configure the UE to measure and report L1-RSRP measurements for the candidate SSBs/CSI-RSs on the SSB-less SCell. For instance, the base station may configure the UE to measure and report L strongest L1-RSRP measurements for the candidate SSBs/CSI-RSs on the SSB-less SCell. In one aspect, the L1-RSRP measurements of the SSBs/CSI-RSs associated with the anchor cell and the L1-RSRP measurements of the candidate SSBs/CSI-RSs associated with the SSB-less SCell may be performed prior to fully training the mapping function.

At 1112, the base station may train a mapping function based on the L1-RSRP measurements of the SSBs/CSI-RSs associated with the anchor cell and the L1-RSRP measurements of the candidate SSBs/CSI-Rs associated with the SSB-less SCell. In another aspect, the L1-RSRP measurements of the SSBs/CSI-RSs associated with the anchor cell and the L1-RSRP measurements of the candidate SSBs/CSI-RSs associated with the SSB-less SCell may be performed sporadically to refine the mapping function after training.

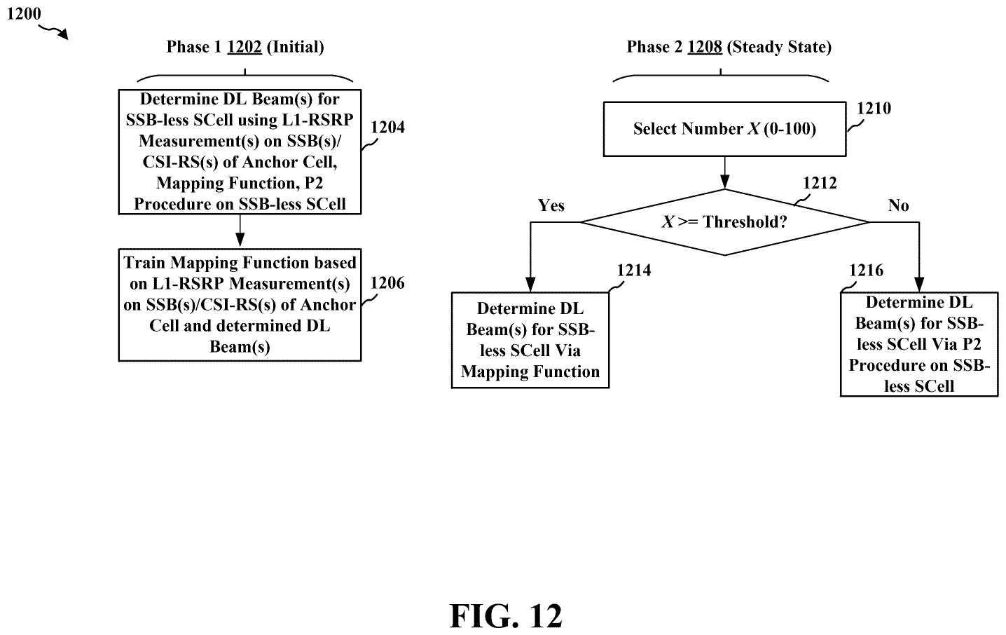

FIG. 12 is a diagram 1200 illustrating an example of a two-phase mapping function training. In a first phase 1202, at 1204, a base station (e.g., the base station 804) may determine a DL beam (or DL Beams) for a SSB-less SCell using L1-RSRP measurement(s) on the SSB(s)/CSI-RS(s) associated with the anchor cell described above in the descriptions of FIGS. 8-9 and using the P2 procedure on the SSB-less SCell described above in the descriptions of FIGS. 6 and 10. The first phase 1202 may be an initial phase that is associated with a mapping function not being fully trained. In the first phase 1202, at 1206, the base station may train the mapping function based on the L1-RSRP measurement(s) performed on the SSB(s)/CSI-RS(s) associated with the anchor cell and SSB-less SCell.

In a second phase 1208 (i.e., a steady state phase) that may occur after the first phase 1202, at 1210, the base station may select a number X between “0” and “100,” inclusive. The base station may select the number X randomly. At 1212, the base station may determine whether X is greater than or equal to a threshold. In an example, the threshold may range from “1” to “10.” For instance, the threshold may be “1” or “10.”

At 1214, upon positive determination, the base station may determine a DL beam (or DL beams) for the SSB-less SCell via a mapping function (e.g., using the processes described above in the descriptions of FIGS. 8-9). The mapping function may be the look-up table 902 or the ML model 904. At 1216, upon negative determination, the base station may determine the DL beam (or DL beams) for the SSB-less SCell using the P2 procedure on the SSB-less SCell described above in the descriptions of FIGS. 6 and 10. The second phase 1208 may be employed when the mapping function is in a relatively “refined” state. In one aspect, if the mapping function and the P2 procedure identify/select the same DL beam (or DL beams) associated with the SSB-less SCell, the base station may assume that the mapping function is working properly. In another aspect, if the mapping function and the P2 procedure identify/select a different DL beam (or DL beams) associated with the SSB-less SCell, the base station may transition back to the first phase 1202 to further train the mapping function.

In one aspect, for X % of DL beam determination on a SSB-less SCell, the base station may rely upon K RSRP measurements on SSBs/CSI-RSs on the anchor cell and the mapping function. In an example, X may be 90% or 99%. For (100−X) % of DL beam determination on the SSB-less SCell, the base station may rely upon K RSRP measurements on SSBs/CSI-RSs on the anchor cell and a P2 procedure on the SSB-less SCell.

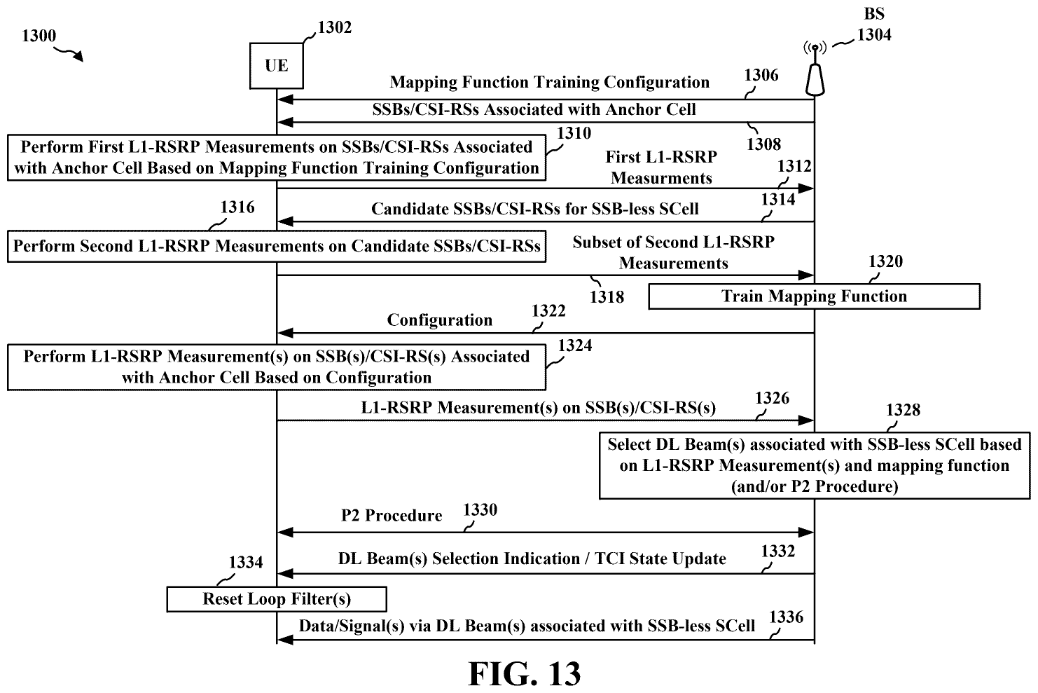

FIG. 13 is a diagram 1300 illustrating example communications between a UE 1302 and a base station 1304. In example, the UE 1302 may be the UE 104, the UE 350, the UE 504, the UE 608, and/or the UE 802. In an example, the base station 1304 may be the base station 102, the base station 310, the base station 502, the base station 610, and/or the base station 804.

At 1306, the UE 1302 may receive a mapping function training configuration from the base station 1304. The mapping function training configuration may be associated with aspects described above in the descriptions of FIGS. 9, 11, and 12. At 1308, the UE 1302 may receive SSBs/CSI-RSs associated with an anchor cell, where the SSBs/CSI-RSs may be associated with different DL beams of the anchor cell. At 1310, the UE 1302 may perform first L1-RSRP measurements on the SSBs/CSI-RSs associated with the anchor cell based on the mapping function training configuration.

At 1312, the UE 1302 may transmit the first L1-RSRP measurements to the base station 1304. At 1314, the UE 1302 may receive indications of candidate SSBs/CSI-RSs for a SSB-less SCell from the base station 1304. At 1316, the UE 1302 may perform second L1-RSRP measurements on the candidate SSBs/CSI-RSs for the SSB-less SCell. At 1318, the UE 1302 may transmit a subset of the second L1-RSRP measurements to the base station 1304. In an example, the subset may be a number of strongest L1-RSRP measurements in the second L1-RSRP measurements. At 1320, the base station 1304 may train/construct/generate a mapping function (e.g., the look-up table 902, the ML model 904) based on the first L1-RSRP measurements and the second L1-RSRP measurements.

At 1322, the UE 1302 may receive a configuration from the base station 1304. At 1324, the UE 1302 may perform L1-RSRP measurement(s) on SSB(s)/CSI-RS(s) associated with the anchor cell based on the configuration. At 1326, the UE 1302 may transmit the L1-RSRP measurement(s) to the base station 1304 along with indications of an SSB/CSI-RS associated with each of the L1-RSRP measurement(s). At 1328, the base station may select a DL beam (or DL beams) associated with the SSB-less SCell based on the L1-RSRP measurement(s), the mapping function, and/or a P2 procedure (e.g., the P2 beam refinement procedure 604). In one aspect, at 1330, the base station may initiate the P2 procedure (e.g., when the base station 1304 cannot select a DL beam (or DL beams) using the mapping function).

At 1332, the UE 1302 may receive an indication of the DL beam (or DL beams) associated with the SSB-less SCell and/or a TCI state update from the base station 1304. At 1334, the UE 1302 may reset one or more loop filters (e.g., an AGC loop, a TTL, a FTL loop) based on the indication received at 1332. At 1336, the UE 1302 may receive data/signal(s) via the DL beam (or DL beams) associated with the SSB-less SCell.

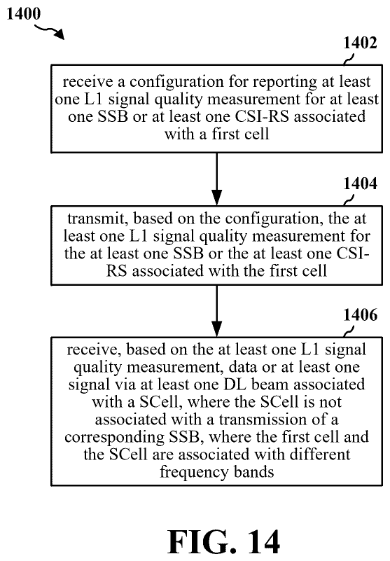

FIG. 14 is a flowchart 1400 of a method of wireless communication. The method may be performed by a UE (e.g., the UE 104, the UE 350, the UE 504, the UE 608, the UE 802, the apparatus 1804). The method may be associated with various advantages at the UE, such as increased communications reliability via a SSB-less SCell. In an example, the method may be performed by the reporting component 198.

At 1402, the UE receives a configuration for reporting at least one L1 signal quality measurement for at least one SSB or at least one CSI-RS associated with a first cell. For example, FIG. 13 at 1322 shows that the UE 1302 may receive a configuration for reporting at least one L1 signal quality measurement for at least one SSB or at least one CSI-RS associated with an anchor cell (i.e., a first cell). In another example, FIG. 8 illustrates DL beams associated with an anchor cell that carry SSB(s) or CSI-RS(s). In an example, 1402 may be performed by the reporting component 198.

At 1404, the UE transmits, based on the configuration, the at least one L1 signal quality measurement for the at least one SSB or the at least one CSI-RS associated with the first cell. For example, FIG. 13 at 1326 shows that the UE 1302 may transmit L1-RSRP measurement(s) performed on SSB(s)/CSI-RS(s) associated with an anchor cell. In another example, FIG. 8 depicts RSRP measurements performed by the UE 802 on DL beams associated with an anchor cell (i.e., a first cell) that carry SSBs/CSI-RSs. In an example, 1404 may be performed by the reporting component 198.

At 1406, the UE receives, based on the at least one L1 signal quality measurement, data or at least one signal via at least one DL beam associated with a SCell, where the SCell is not associated with a transmission of a corresponding SSB, where the first cell and the SCell are associated with different frequency bands. For example, FIG. 13 at 1336 shows that the UE 1302 may receive data/signal(s) via DL beam(s) associated with a SSB-less SCell (i.e., a SCell). In an example, the SCell may be the SSB-less SCell associated with the first DL beam 810a, the second DL beam 810b, and the third DL beam 810c illustrated in FIG. 8. Furthermore, FIG. 8 also shows that an anchor cell (i.e., a first cell) and a SSB-less SCell (i.e., a SCell) may be associated with different frequency bands. In an example, 1406 may be performed by the reporting component 198.

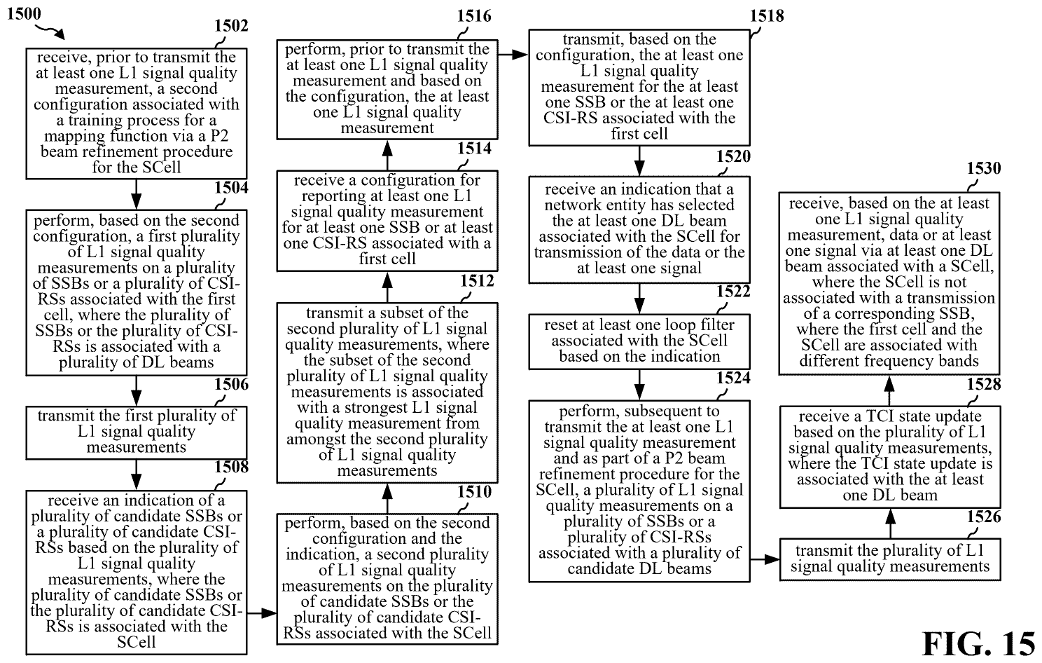

FIG. 15 is a flowchart 1500 of a method of wireless communication. The method may be performed by a UE (e.g., the UE 104, the UE 350, the UE 504, the UE 608, the UE 802, the apparatus 1804). The method may be associated with various advantages at the UE, such as increased communications reliability via a SSB-less SCell. In an example, the method (including the various aspects detailed below) may be performed by the reporting component 198.

At 1514, the UE receives a configuration for reporting at least one L1 signal quality measurement for at least one SSB or at least one CSI-RS associated with a first cell. For example, FIG. 13 at 1322 shows that the UE 1302 may receive a configuration for reporting at least one L1 signal quality measurement for at least one SSB or at least one CSI-RS associated with an anchor cell (i.e., a first cell). In another example, FIG. 8 illustrates DL beams associated with an anchor cell that carry SSB(s) or CSI-RS(s). In an example, 1514 may be performed by the reporting component 198.

At 1518, the UE transmits, based on the configuration, the at least one L1 signal quality measurement for the at least one SSB or the at least one CSI-RS associated with the first cell. For example, FIG. 13 at 1326 shows that the UE 1302 may transmit L1-RSRP measurement(s) performed on SSB(s)/CSI-RS(s) associated with an anchor cell. In another example, FIG. 8 depicts RSRP measurements performed by the UE 802 on DL beams associated with an anchor cell (i.e., a first cell) that carry SSBs/CSI-RSs. In an example, 1518 may be performed by the reporting component 198.

At 1530, the UE receives, based on the at least one L1 signal quality measurement, data or at least one signal via at least one DL beam associated with a SCell, where the SCell is not associated with a transmission of a corresponding SSB, where the first cell and the SCell are associated with different frequency bands. For example, FIG. 13 at 1336 shows that the UE 1302 may receive data/signal(s) via DL beam(s) associated with a SSB-less SCell (i.e., a SCell). In an example, the SCell may be the SSB-less SCell associated with the first DL beam 810a, the second DL beam 810b, and the third DL beam 810c illustrated in FIG. 8. Furthermore, FIG. 8 also shows that an anchor cell (i.e., a first cell) and a SSB-less SCell (i.e., a SCell) may be associated with different frequency bands. In an example, 1530 may be performed by the reporting component 198.

In one aspect, at 1520, the UE may receive an indication that a network entity has selected the at least one DL beam associated with the SCell for transmission of the data or the at least one signal. For example, FIG. 13 at 1332 shows that the UE 1302 may receive a DL beam selection indication indicating that the base station 1304 has selected DL beam(s) associated with a SSB-less SCell. In an example, 1520 may be performed by the reporting component 198.

In one aspect, at 1522, the UE may reset at least one loop filter associated with the SCell based on the indication. For example, FIG. 13 at 1334 shows that the UE 1302 may reset loop filter(s) associated with a SSB-less SCell based on receiving the DL beam selection indication at 1332. In an example, 1522 may be performed by the reporting component 198.

In one aspect, the at least one loop filter may include: an AGC loop, a time tracking loop, or a frequency tracking loop. For example, the loop filter(s) reset at 1334 may include an AGC loop, a time tracking loop, or a frequency tracking loop.

In one aspect, at 1524, the UE may perform, subsequent to transmitting the at least one L1 signal quality measurement and as part of a P2 beam refinement procedure for the SCell, a plurality of L1 signal quality measurements on a plurality of SSBs or a plurality of CSI-RSs associated with a plurality of candidate DL beams. For example, FIG. 13 at 1330 shows that the UE 1302 and the base station 1304 may engage in a P2 procedure subsequent to the UE 1302 transmitting the L1-RSRP measurement(s) at 1326. The P2 procedure may include performing a plurality of L1 signal quality measurements on a plurality of SSBs or a plurality of CSI-RSs associated with a plurality of candidate DL beams. The P2 procedure may include aspects described in the description of FIG. 6. In an example, 1524 may be performed by the reporting component 198.

In one aspect, at 1526, the UE may transmit the plurality of L1 signal quality measurements. For example, FIG. 13 at 1330 shows that the UE 1302 and the base station 1304 may engage in a P2 procedure. The P2 procedure may include transmitting the plurality of L1 signal quality measurements. The P2 procedure may include aspects described in the description of FIG. 6. In an example, 1526 may be performed by the reporting component 198.

In one aspect, at 1528, the UE may receive a TCI state update based on the plurality of L1 signal quality measurements, where the TCI state update may be associated with the at least one DL beam. For example, FIG. 13 at 1330 shows that the UE 1302 and the base station 1304 may engage in a P2 procedure. The P2 procedure may include receiving a TCI state update based on the plurality of L1 signal quality measurements. In another example, FIG. 13 at 1332 shows that the UE 1302 may receive a TCI state update, where the TCI state update may be based on the plurality of L1 signal quality measurements. The P2 procedure may include aspects described in the description of FIG. 6. In an example, 1528 may be performed by the reporting component 198.

In one aspect, at 1502, the UE may receive, prior to transmitting the at least one L1 signal quality measurement, a second configuration associated with a training process for a mapping function via a P2 beam refinement procedure for the SCell. For example, FIG. 13 at 1306 shows that the UE 1302 may receive a mapping function training configuration prior to transmitting the L1-RSRP measurements at 1326. In an example, the mapping function may be the look-up table 902 or the ML model 904. The P2 beam refinement procedure for the SCell may include aspects described above in the description of FIG. 6. In an example, 1502 may be performed by the reporting component 198.

In one aspect, at 1504, the UE may perform, based on the second configuration, a first plurality of L1 signal quality measurements on a plurality of SSBs or a plurality of CSI-RSs associated with the first cell, where the plurality of SSBs or the plurality of CSI-RSs may be associated with a plurality of DL beams. For example, FIG. 13 at 1310 shows that the UE 1302 may perform first L1-RSRP measurements on SSBs/CSI-RSs associated with an anchor cell based on the mapping function training configuration. In an example, the plurality of SSBs or the plurality of CSI-RSs may be carried by the DL beams illustrated in FIG. 8 that are associated with the anchor cell. In an example, 1504 may be performed by the reporting component 198.

In one aspect, at 1506, the UE may transmit the first plurality of L1 signal quality measurements. For example, FIG. 13 at 1312 shows that the UE 1302 may transmit the first L1-RSRP measurements performed on the SSBs/CSI-RSs associated with the anchor cell. In an example, 1506 may be performed by the reporting component 198.

In one aspect, at 1508, the UE may receive an indication of a plurality of candidate SSBs or a plurality of candidate CSI-RSs based on the plurality of L1 signal quality measurements, where the plurality of candidate SSBs or the plurality of candidate CSI-RSs may be associated with the SCell. For example, FIG. 13 at 1314 shows that the UE 1302 may receive indications of candidate SSBs/CSI-RSs for a SSB-less SCell from the base station 1304. In an example, the plurality of candidate SSBs or the plurality of candidate CSI-RSs may be associated with the SSB-less SCell in FIG. 8. In an example, 1508 may be performed by the reporting component 198.

In one aspect, at 1510, the UE may perform, based on the second configuration and the indication, a second plurality of L1 signal quality measurements on the plurality of candidate SSBs or the plurality of candidate CSI-RSs associated with the SCell. For example, FIG. 13 at 1316 shows that the UE 1302 may perform second L1-RSRP measurements on the candidate SSBs/CSI-RSs for the SSB-less SCell. In an example, 1510 may be performed by the reporting component 198.

In one aspect, at 1512, the UE may transmit a subset of the second plurality of L1 signal quality measurements, where the subset of the second plurality of L1 signal quality measurements may be associated with a strongest L1 signal quality measurement from amongst the second plurality of L1 signal quality measurements. For example, FIG. 13 at 1318 shows that the UE 1302 may transmit a subset of the second L1-RSRP measurements. The subset of the second L1-RSRP measurements may be associated with a strongest L1-RSRP from amongst the second L1-RSRP measurements. In an example, 1512 may be performed by the reporting component 198.

In one aspect, the at least one L1 signal quality measurement for the at least one SSB or the at least one CSI-RS associated with the first cell may be transmitted in a report, where the report may include an indication that a subset of the at least one SSB or the at least one CSI-RS were not detected. For example, the report may be the L1 report 808. As depicted in FIG. 8, the L1 report 808 may include an indication that a SSB/CSI-RS associated with an anchor cell was not detected.

In one aspect, the at least one L1 signal quality measurement may include at least one RSRP measurement. For example, FIG. 8 depicts RSRP measurements (i.e., L1 signal quality measurements) performed on SSBs/CSI-RSs associated with an anchor cell.

In one aspect, at 1516, the UE may perform, prior to transmit the at least one L1 signal quality measurement and based on the configuration, the at least one L1 signal quality measurement. For example, FIG. 13 at 1324 shows that the UE 1302 may perform L1-RSRP measurement(s) on SSB(s)/CSI-RS(s) associated with an anchor cell based on the configuration received at 1322. In an example, 1516 may be performed by the reporting component 198.

In one aspect, the first cell may be a PCell or a second SCell that is different from the SCell. For example, FIG. 8 shows that the anchor cell (i.e., a first cell) may be a PCell or a second SCell that is different than the SSB-less SCell.

In one aspect, the configuration for reporting the at least one L1 signal quality measurement for the at least one SSB or the at least one CSI-RS may indicate that the UE is to report a strongest L1 signal quality measurement for an SSB of the at least one SSB or a CSI-RS of the at least one CSI-RS from amongst the at least one L1 signal quality measurement for the at least one SSB or the at least one CSI-RS and at least one additional L1 measurement for at least one additional SSB or at least one additional CSI-RS. For example, with reference to FIG. 13, the configuration received by the UE 1302 at 1322 may indicate that the UE 1302 is to report a strongest L1 signal quality measurement for an SSB or a CSI-RS from amongst the at least one L1 signal quality measurement for the at least one SSB or the at least one CSI-RS and at least one additional L1 measurement for at least one additional SSB of the at least one SSB or at least one additional CSI-RS of the at least one CSI-RS.

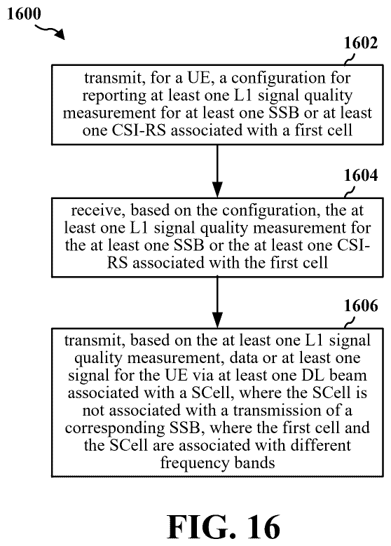

FIG. 16 is a flowchart 1600 of a method of wireless communication. The method may be performed by a network entity (e.g., the base station 102, the base station 310, the base station 502, the base station 610, the base station 804, the network entity 1902). The method may be associated with various advantages at the network entity, such as increased communications reliability with a UE via a SSB-less SCell. In an example, the method may be performed by the BM component 199.

At 1602, the network entity transmits, for a UE, a configuration for reporting at least one L1 signal quality measurement for at least one SSB or at least one CSI-RS associated with a first cell. For example, FIG. 13 at 1322 shows that the base station 1304 may transmit a configuration to the UE 1302 for reporting at least one L1 signal quality measurement for at least one SSB or at least one CSI-RS associated with an anchor cell (i.e., a first cell). In another example, FIG. 8 illustrates DL beams associated with an anchor cell that carry SSB(s) or CSI-RS(s). In an example, 1602 may be performed by the BM component 199.

At 1604, the network entity receives, based on the configuration, the at least one L1 signal quality measurement for the at least one SSB or the at least one CSI-RS associated with the first cell. For example, FIG. 13 at 1326 shows that the base station 1304 may receive L1-RSRP measurement(s) performed on SSB(s)/CSI-RS(s) associated with an anchor cell. In another example, FIG. 8 depicts RSRP measurements performed by the UE 802 on DL beams associated with an anchor cell (i.e., a first cell) that carry SSBs/CSI-RSs. The RSRP measurements may be received by the base station 804. In an example, 1604 may be performed by the BM component 199.

At 1606, the network entity transmits, based on the at least one L1 signal quality measurement, data or at least one signal for the UE via at least one DL beam associated with a SCell, where the SCell is not associated with a transmission of a corresponding SSB, where the first cell and the SCell are associated with different frequency bands. For example, FIG. 13 at 1336 shows that the base station 1304 may transmit data/signal(s) via DL beam(s) associated with a SSB-less SCell (i.e., a SCell). In an example, the SCell may be the SSB-less SCell associated with the first DL beam 810a, the second DL beam 810b, and the third DL beam 810c illustrated in FIG. 8. Furthermore, FIG. 8 also shows that an anchor cell (i.e., a first cell) and a SSB-less SCell (i.e., a SCell) may be associated with different frequency bands. In an example, 1606 may be performed by the BM component 199.

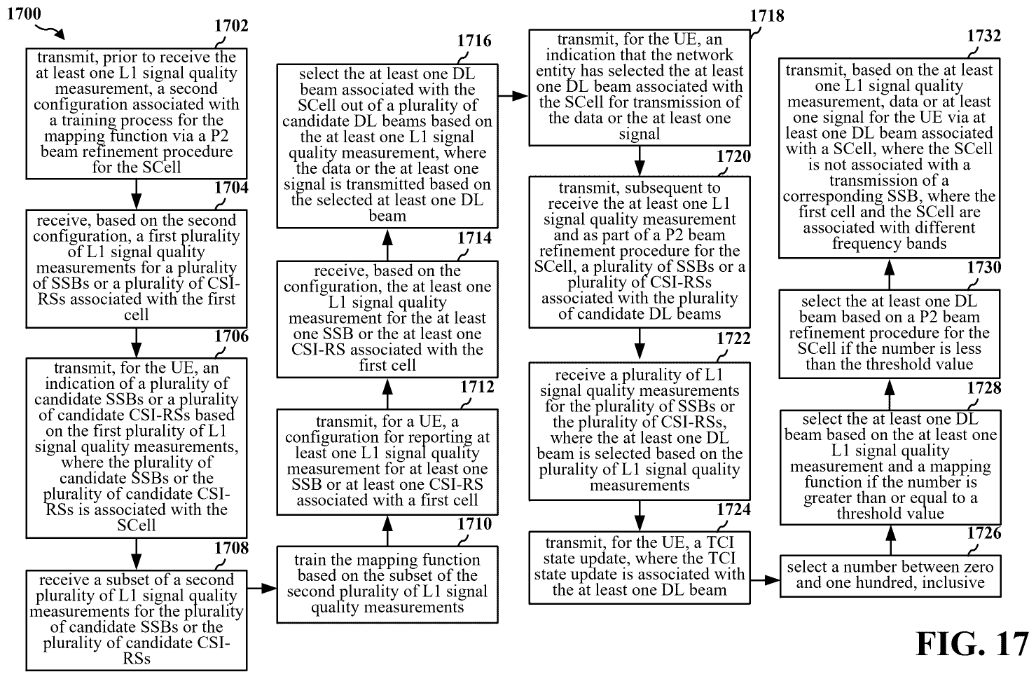

FIG. 17 is a flowchart 1700 of a method of wireless communication. The method may be performed by a network entity (e.g., the base station 102, the base station 310, the base station 502, the base station 610, the base station 804, the network entity 1902). The method may be associated with various advantages at the network entity, such as increased communications reliability with a UE via a SSB-less SCell. In an example, the method (including the various aspects detailed below) may be performed by the BM component 199.

At 1712, the network entity transmits, for a UE, a configuration for reporting at least one L1 signal quality measurement for at least one SSB or at least one CSI-RS associated with a first cell. For example, FIG. 13 at 1322 shows that the base station 1304 may transmit a configuration to the UE 1302 for reporting at least one L1 signal quality measurement for at least one SSB or at least one CSI-RS associated with an anchor cell (i.e., a first cell). In another example, FIG. 8 illustrates DL beams associated with an anchor cell that carry SSB(s) or CSI-RS(s). In an example, 1712 may be performed by the BM component 199.

At 1714, the network entity receives, based on the configuration, the at least one L1 signal quality measurement for the at least one SSB or the at least one CSI-RS associated with the first cell. For example, FIG. 13 at 1326 shows that the base station 1304 may receive L1-RSRP measurement(s) performed on SSB(s)/CSI-RS(s) associated with an anchor cell. In another example, FIG. 8 depicts RSRP measurements performed by the UE 802 on DL beams associated with an anchor cell (i.e., a first cell) that carry SSBs/CSI-RSs. The RSRP measurements may be received by the base station 804. In an example, 1714 may be performed by the BM component 199.

At 1732, the network entity transmits, based on the at least one L1 signal quality measurement, data or at least one signal for the UE via at least one DL beam associated with a SCell, where the SCell is not associated with a transmission of a corresponding SSB, where the first cell and the SCell are associated with different frequency bands. For example, FIG. 13 at 1336 shows that the base station 1304 may transmit data/signal(s) via DL beam(s) associated with a SSB-less SCell (i.e., a SCell). In an example, the SCell may be the SSB-less SCell associated with the first DL beam 810a, the second DL beam 810b, and the third DL beam 810c illustrated in FIG. 8. Furthermore, FIG. 8 also shows that an anchor cell (i.e., a first cell) and a SSB-less SCell (i.e., a SCell) may be associated with different frequency bands. In an example, 1732 may be performed by the BM component 199.

In one aspect, at 1716, the network entity may select the at least one DL beam associated with the SCell out of a plurality of candidate DL beams based on the at least one L1 signal quality measurement, where the data or the at least one signal may be transmitted based on the selected at least one DL beam. For example, FIG. 13 at 1328 shows that the base station 1304 may select DL beam(s) associated with a SSB-less SCell based on L1-RSRP measurement(s). In an example, 1716 may be performed by the BM component 199.

In one aspect, at 1718, the network entity may transmit, for the UE, an indication that the network entity has selected the at least one DL beam associated with the SCell for transmission of the data or the at least one signal. For example, FIG. 13 at 1332 shows that the base station 1304 may transmit a DL beam selection indication for the UE 1302 indicating that the base station 1304 has selected DL beam(s) associated with a SSB-less SCell. In an example, 1718 may be performed by the BM component 199.

In one aspect, at 1720, the network entity may transmit, subsequent to receiving the at least one L1 signal quality measurement and as part of a P2 beam refinement procedure for the SCell, a plurality of SSBs or a plurality of CSI-RSs associated with the plurality of candidate DL beams. For example, FIG. 13 at 1330 shows that the UE 1302 and the base station 1304 may engage in a P2 procedure subsequent to the base station 1304 receiving the L1-RSRP measurement(s) at 1326. The P2 procedure may include transmitting a plurality of SSBs or a plurality of CSI-RSs associated with the plurality of candidate DL beams. The P2 procedure may include aspects described in the description of FIG. 6. In an example, 1720 may be performed by the BM component 199.

In one aspect, at 1722, the network entity may receive a plurality of L1 signal quality measurements for the plurality of SSBs or the plurality of CSI-RSs, where the at least one DL beam may be selected based on the plurality of L1 signal quality measurements. For example, FIG. 13 at 1330 shows that the UE 1302 and the base station 1304 may engage in a P2 procedure. The P2 procedure may include receiving the plurality of L1 signal quality measurements. The P2 procedure may include aspects described in the description of FIG. 6. In an example, 1722 may be performed by the BM component 199.

In one aspect, at 1724, the network entity may transmit, for the UE, a TCI state update, where the TCI state update may be associated with the at least one DL beam. For example, FIG. 13 at 1330 shows that the UE 1302 and the base station 1304 may engage in a P2 procedure. The P2 procedure may include transmitting a TCI state update based on the plurality of L1 signal quality measurements. In another example, FIG. 13 at 1332 shows that the base station 1304 may transmit a TCI state update, where the TCI state update may be based on the plurality of L1 signal quality measurements. The P2 procedure may include aspects described in the description of FIG. 6. In an example, 1724 may be performed by the BM component 199.

In one aspect, the DL beam associated with the SCell may be selected based on a mapping function between the first cell and the SCell, where the mapping function may map the at least one L1 signal quality measurement associated with the first cell to the at least one DL beam associated with the SCell. For example, FIG. 13 at 1328 shows that the DL beam(s) associated with the SSB-less SCell may be selected based on a mapping function, where the mapping function may map the L1-RSRP measurement(s) associated with the anchor cell to the DL beam(s) associated with the SSB-less SCell.

In one aspect, the mapping function may include a look-up table or a non-linear function. For example, the mapping function may be the look-up table 902 or the ML model 904 (i.e., a non-linear function).

In one aspect, at 1702, the network entity may transmit, prior to receiving the at least one L1 signal quality measurement, a second configuration associated with a training process for the mapping function via a P2 beam refinement procedure for the SCell. For example, FIG. 13 at 1306 shows that the base station 1304 may transmit a mapping function training configuration prior to receiving the L1-RSRP measurements at 1326. In an example, the mapping function may be the look-up table 902 or the ML model 904. The P2 beam refinement procedure for the SCell may include aspects described above in the description of FIG. 6. In an example, 1702 may be performed by the BM component 199.

In one aspect, at 1704, the network entity may receive, based on the second configuration, a first plurality of L1 signal quality measurements for a plurality of SSBs or a plurality of CSI-RSs associated with the first cell. For example, FIG. 13 at 1312 shows that the base station 1304 may receive the first L1-RSRP measurements performed on the SSBs/CSI-RSs associated with the anchor cell. In an example, 1704 may be performed by the BM component 199.

In one aspect, at 1706, the network entity may transmit, for the UE, an indication of a plurality of candidate SSBs or a plurality of candidate CSI-RSs based on the first plurality of L1 signal quality measurements, where the plurality of candidate SSBs or the plurality of candidate CSI-RSs may be associated with the SCell. For example, FIG. 13 at 1314 shows that the base station 1304 may transmit indications of candidate SSBs/CSI-RSs for a SSB-less SCell to the UE 1302. In an example, the plurality of candidate SSBs or the plurality of candidate CSI-RSs may be associated with the SSB-less SCell in FIG. 8. In an example, 1706 may be performed by the BM component 199.

In one aspect, at 1708, the network entity may receive a subset of a second plurality of L1 signal quality measurements for the plurality of candidate SSBs or the plurality of candidate CSI-RSs. For example, FIG. 13 at 1318 shows that the base station 1304 may receive a subset of the second L1-RSRP measurements. In an example, 1708 may be performed by the BM component 199.

In one aspect, at 1710, the network entity may train the mapping function based on the subset of the second plurality of L1 signal quality measurements. For example, FIG. 13 at 1320 shows that the base station 1304 may train the mapping function based on the subset of second L1-RSRP measurements received at 1318. In another example, training the mapping function may include aspects described in the description of FIG. 11. In yet another example, training the mapping function may include aspects described in the description of FIG. 4. In an example, 1710 may be performed by the BM component 199.

In one aspect, the mapping function may be constructed based on a cross-band beam calibration procedure. For example, with reference to FIG. 13 at 1320, training the mapping function may include constructing the mapping function based on a cross-band beam calibration procedure.

In one aspect, the DL beam associated with the SCell may be additionally selected based on a P2 beam refinement procedure. For example, FIG. 13 at 1328 shows that the base station 1304 may additionally select the DL beam(s) associated with the SSB-less SCell based on a P2 procedure. The P2 procedure may include aspects described in FIG. 6. In another example, FIG. 10 illustrates an example of determining a DL beam for a SSB-less SCell and the example may include initiating a P2 procedure on the SSB-less SCell at 1020. In yet another example, with reference to FIG. 12 at 1204, the first phase 1202 of the two-phase mapping function training may include determining DL beam(s) for a SSB-less SCell using a P2 procedure on the SSB-less SCell.

In one aspect, at 1726, the network entity may select a number between zero and one hundred, inclusive. For example, FIG. 12 at 1210 shows that a base station may select a number X between 0-100, inclusive. In an example, 1726 may be performed by the BM component 199.

In one aspect, at 1728, the network entity may select the at least one DL beam based on the at least one L1 signal quality measurement and a mapping function if the number is greater than or equal to a threshold value. For example, FIG. 12 at 1214 shows that the base station may determine DL beam(s) for the SSB-less SCell via a mapping function if the number X is greater than or equal to a threshold. In an example, the mapping function may be the look-up table 902 or the ML model 904. In an example, 1728 may be performed by the BM component 199.

In one aspect, at 1730, the network entity may select the at least one DL beam based on a P2 beam refinement procedure for the SCell if the number is less than the threshold value. For example, FIG. 12 at 1216 shows that the base station may determine DL beam(s) for the SSB-less SCell via a P2 procedure on the SSB-less SCell if the number X is less than a threshold. In an example, 1730 may be performed by the BM component 199.

In one aspect, the at least one L1 signal quality measurement for the at least one SSB or the at least one CSI-RS associated with the first cell may be received in a report, where the report may include an indication that a subset of the at least one SSB or the at least one CSI-RS were not detected. For example, the report may be the L1 report 808. As depicted in FIG. 8, the L1 report 808 may include an indication that a SSB/CSI-RS associated with an anchor cell was not detected.

In one aspect, the at least one L1 signal quality measurement may include at least one RSRP measurement. For example, FIG. 8 depicts RSRP measurements (i.e., L1 signal quality measurements) performed on SSBs/CSI-RSs associated with an anchor cell.

In one aspect, the first cell may be a PCell or a second SCell that is different from the SCell. For example, FIG. 8 shows that the anchor cell (i.e., a first cell) may be a PCell or a second SCell that is different than the SSB-less SCell.

In one aspect, the configuration for reporting the at least one L1 signal quality measurement for the at least one SSB or the at least one CSI-RS may indicate that the UE is to report a strongest L1 signal quality measurement for an SSB of the at least one SSB or a CSI-RS of the at least one CSI-RS from amongst the at least one L1 signal quality measurement and at least one additional L1 measurement for at least one additional SSB of the at least one SSB or at least one additional CSI-RS of the at least one CSI-RS. For example, with reference to FIG. 13, the configuration transmitted by the base station 1304 at 1322 may indicate that the UE 1302 is to report a strongest L1 signal quality measurement for an SSB or a CSI-RS from amongst the at least one L1 signal quality measurement for the at least one SSB or the at least one CSI-RS and at least one additional L1 measurement for at least one additional SSB or at least one additional CSI-RS.

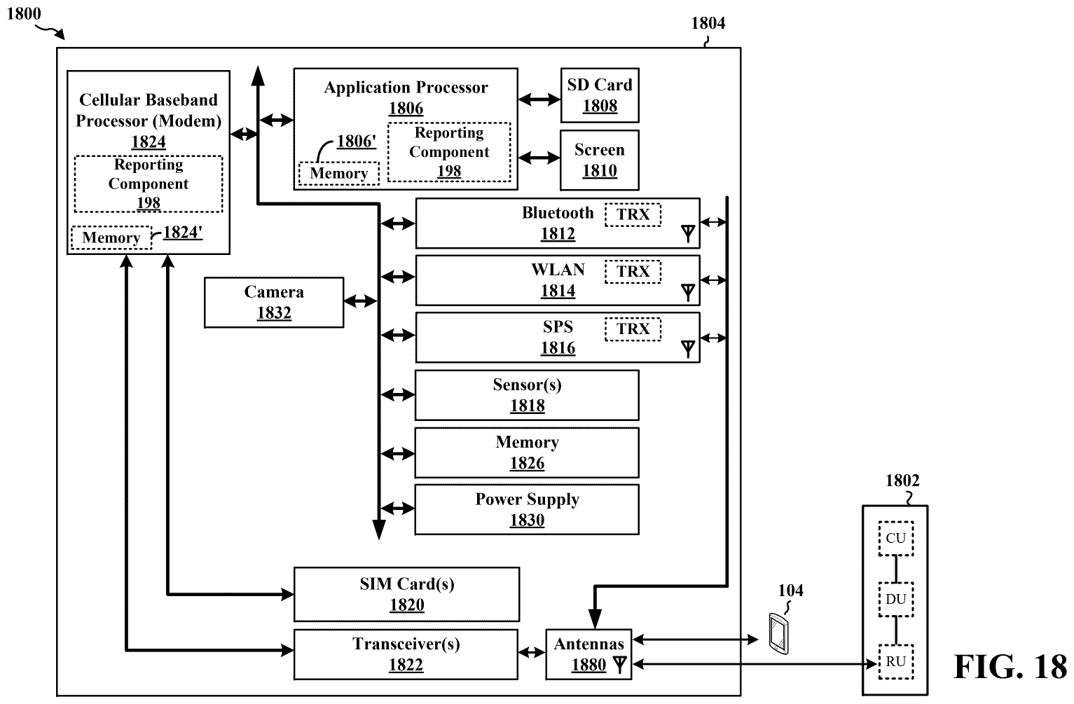

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

As discussed supra, the reporting component 198 is configured to receive a configuration for reporting at least one L1 signal quality measurement for at least one SSB or at least one CSI-RS associated with a first cell. The reporting component 198 is configured to transmit, based on the configuration, the at least one L1 signal quality measurement for the at least one SSB or the at least one CSI-RS associated with the first cell. The reporting component 198 is configured to receive, based on the at least one L1 signal quality measurement, data or at least one signal via at least one DL beam associated with a SCell, where the SCell is not associated with a transmission of a corresponding SSB, where the first cell and the SCell are associated with different frequency bands. The reporting component 198 is configured to receive an indication that a network entity has selected the at least one DL beam associated with the SCell for transmission of the data or the at least one signal. The reporting component 198 is configured to reset at least one loop filter associated with the SCell based on the indication. The reporting component 198 is configured to perform, subsequent to transmit the at least one L1 signal quality measurement and as part of a P2 beam refinement procedure for the SCell, a plurality of L1 signal quality measurements on a plurality of SSBs or a plurality of CSI-RSs associated with a plurality of candidate DL beams. The reporting component 198 is configured to transmit the plurality of L1 signal quality measurements. The reporting component 198 is configured to receive a TCI state update based on the plurality of L1 signal quality measurements, where the TCI state update is associated with the at least one DL beam. The reporting component 198 is configured to receive, prior to transmit the at least one L1 signal quality measurement, a second configuration associated with a training process for a mapping function via a P2 beam refinement procedure for the SCell. The reporting component 198 is configured to perform, based on the second configuration, a first plurality of L1 signal quality measurements on a plurality of SSBs or a plurality of CSI-RSs associated with the first cell, where the plurality of SSBs or the plurality of CSI-RSs is associated with a plurality of DL beams. The reporting component 198 is configured to transmit the first plurality of L1 signal quality measurements. The reporting component 198 is configured to receive an indication of a plurality of candidate SSBs or a plurality of candidate CSI-RSs based on the plurality of L1 signal quality measurements, where the plurality of candidate SSBs or the plurality of candidate CSI-RSs is associated with the SCell. The reporting component 198 is configured to perform, based on the second configuration and the indication, a second plurality of L1 signal quality measurements on the plurality of candidate SSBs or the plurality of candidate CSI-RSs associated with the SCell. The reporting component 198 is configured to transmit a subset of the second plurality of L1 signal quality measurements, where the subset of the second plurality of L1 signal quality measurements is associated with a strongest L1 signal quality measurement from amongst the second plurality of L1 signal quality measurements. The reporting component 198 is configured to perform, prior to transmit the at least one L1 signal quality measurement and based on the configuration, the at least one L1 signal quality measurement. The reporting component 198 may be within the cellular baseband processor 1824, the application processor 1806, or both the cellular baseband processor 1824 and the application processor 1806. The reporting component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, includes means for receiving a configuration for reporting at least one L1 signal quality measurement for at least one SSB or at least one CSI-RS associated with a first cell. In one configuration, the apparatus 1804, and in particular the cellular baseband processor 1824 and/or the application processor 1806, includes means for transmitting, based on the configuration, the at least one L1 signal quality measurement for the at least one SSB or the at least one CSI-RS associated with the first cell. In one configuration, the apparatus 1804, and in particular the cellular baseband processor 1824 and/or the application processor 1806, includes means for receiving, based on the at least one L1 signal quality measurement, data or at least one signal via at least one DL beam associated with a SCell, where the SCell is not associated with a transmission of a corresponding SSB, where the first cell and the SCell are associated with different frequency bands. In one configuration, the apparatus 1804, and in particular the cellular baseband processor 1824 and/or the application processor 1806, includes means for receiving an indication that a network entity has selected the at least one DL beam associated with the SCell for transmission of the data or the at least one signal. In one configuration, the apparatus 1804, and in particular the cellular baseband processor 1824 and/or the application processor 1806, includes means for resetting at least one loop filter associated with the SCell based on the indication. In one configuration, the apparatus 1804, and in particular the cellular baseband processor 1824 and/or the application processor 1806, includes means for performing, subsequent to transmitting the at least one L1 signal quality measurement and as part of a P2 beam refinement procedure for the SCell, a plurality of L1 signal quality measurements on a plurality of SSBs or a plurality of CSI-RSs associated with a plurality of candidate DL beams. In one configuration, the apparatus 1804, and in particular the cellular baseband processor 1824 and/or the application processor 1806, includes means for transmitting the plurality of L1 signal quality measurements. In one configuration, the apparatus 1804, and in particular the cellular baseband processor 1824 and/or the application processor 1806, includes means for receiving a TCI state update based on the plurality of L1 signal quality measurements, where the TCI state update is associated with the at least one DL beam. In one configuration, the apparatus 1804, and in particular the cellular baseband processor 1824 and/or the application processor 1806, includes means for receiving, prior to transmitting the at least one L1 signal quality measurement, a second configuration associated with a training process for a mapping function via a P2 beam refinement procedure for the SCell. In one configuration, the apparatus 1804, and in particular the cellular baseband processor 1824 and/or the application processor 1806, includes means for performing, based on the second configuration, a first plurality of L1 signal quality measurements on a plurality of SSBs or a plurality of CSI-RSs associated with the first cell, where the plurality of SSBs or the plurality of CSI-RSs is associated with a plurality of DL beams. In one configuration, the apparatus 1804, and in particular the cellular baseband processor 1824 and/or the application processor 1806, includes means for transmitting the first plurality of L1 signal quality measurements. In one configuration, the apparatus 1804, and in particular the cellular baseband processor 1824 and/or the application processor 1806, includes means for receiving an indication of a plurality of candidate SSBs or a plurality of candidate CSI-RSs based on the plurality of L1 signal quality measurements, where the plurality of candidate SSBs or the plurality of candidate CSI-RSs is associated with the SCell. In one configuration, the apparatus 1804, and in particular the cellular baseband processor 1824 and/or the application processor 1806, includes means for performing, based on the second configuration and the indication, a second plurality of L1 signal quality measurements on the plurality of candidate SSBs or the plurality of candidate CSI-RSs associated with the SCell. In one configuration, the apparatus 1804, and in particular the cellular baseband processor 1824 and/or the application processor 1806, includes means for transmitting a subset of the second plurality of L1 signal quality measurements, where the subset of the second plurality of L1 signal quality measurements is associated with a strongest L1 signal quality measurement from amongst the second plurality of L1 signal quality measurements. In one configuration, the apparatus 1804, and in particular the cellular baseband processor 1824 and/or the application processor 1806, includes means for performing, prior to transmitting the at least one L1 signal quality measurement and based on the configuration, the at least one L1 signal quality measurement. The means may be the reporting component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

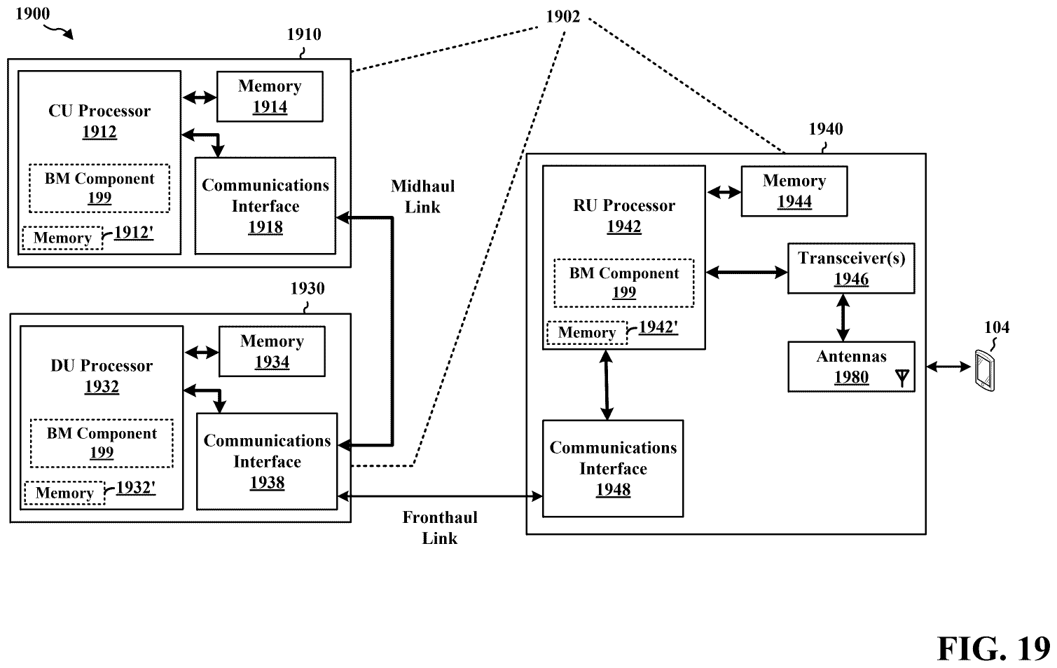

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the BM component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the BM component 199 is configured to transmit, for a UE, a configuration for reporting at least one L1 signal quality measurement for at least one SSB or at least one CSI-RS associated with a first cell. The BM component 199 is configured to receive, based on the configuration, the at least one L1 signal quality measurement for the at least one SSB or the at least one CSI-RS associated with the first cell. The BM component 199 is configured to transmit, based on the at least one L1 signal quality measurement, data or at least one signal for the UE via at least one DL beam associated with a SCell, where the SCell is not associated with a transmission of a corresponding SSB, where the first cell and the SCell are associated with different frequency bands. The BM component 199 is configured to select the at least one DL beam associated with the SCell out of a plurality of candidate DL beams based on the at least one L1 signal quality measurement, where the data or the at least one signal is transmitted based on the selected at least one DL beam. The BM component 199 is configured to transmit, for the UE, an indication that the network entity has selected the at least one DL beam associated with the SCell for transmission of the data or the at least one signal. The BM component 199 is configured to transmit, subsequent to receive the at least one L1 signal quality measurement and as part of a P2 beam refinement procedure for the SCell, a plurality of SSBs or a plurality of CSI-RSs associated with the plurality of candidate DL beams. The BM component 199 is configured to receive a plurality of L1 signal quality measurements for the plurality of SSBs or the plurality of CSI-RSs, where the at least one DL beam is selected based on the plurality of L1 signal quality measurements. The BM component 199 is configured to transmit, for the UE, a TCI state update, where the TCI state update is associated with the at least one DL beam. The BM component 199 is configured to transmit, prior to receive the at least one L1 signal quality measurement, a second configuration associated with a training process for the mapping function via a P2 beam refinement procedure for the SCell. The BM component 199 is configured to receive, based on the second configuration, a first plurality of L1 signal quality measurements for a plurality of SSBs or a plurality of CSI-RSs associated with the first cell. The BM component 199 is configured to transmit, for the UE, an indication of a plurality of candidate SSBs or a plurality of candidate CSI-RSs based on the first plurality of L1 signal quality measurements, where the plurality of candidate SSBs or the plurality of candidate CSI-RSs is associated with the SCell. The BM component 199 is configured to receive a subset of a second plurality of L1 signal quality measurements for the plurality of candidate SSBs or the plurality of candidate CSI-RSs. The BM component 199 is configured to train the mapping function based on the subset of the second plurality of L1 signal quality measurements. The BM component 199 is configured to select a number between zero and one hundred, inclusive. The BM component 199 is configured to select the at least one DL beam based on the at least one L1 signal quality measurement and a mapping function if the number is greater than or equal to a threshold value. The BM component 199 is configured to select the at least one DL beam based on a P2 beam refinement procedure for the SCell if the number is less than the threshold value. The BM component 199 may be within one or more processors of one or more of the CU 1910, DU 1930, and the RU 1940. The BM component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 includes means for transmitting, for a UE, a configuration for reporting at least one L1 signal quality measurement for at least one SSB or at least one CSI-RS associated with a first cell. In one configuration, the network entity 1902 includes means for receiving, based on the configuration, the at least one L1 signal quality measurement for the at least one SSB or the at least one CSI-RS associated with the first cell. In one configuration, the network entity 1902 includes means for transmitting, based on the at least one L1 signal quality measurement, data or at least one signal for the UE via at least one DL beam associated with a SCell, where the SCell is not associated with a transmission of a corresponding SSB, where the first cell and the SCell are associated with different frequency bands. In one configuration, the network entity 1902 includes means for selecting the at least one DL beam associated with the SCell out of a plurality of candidate DL beams based on the at least one L1 signal quality measurement, where the data or the at least one signal is transmitted based on the selected at least one DL beam. In one configuration, the network entity 1902 includes means for transmitting, for the UE, an indication that the network entity has selected the at least one DL beam associated with the SCell for transmission of the data or the at least one signal. In one configuration, the network entity 1902 includes means for transmitting, subsequent to receiving the at least one L1 signal quality measurement and as part of a P2 beam refinement procedure for the SCell, a plurality of SSBs or a plurality of CSI-RSs associated with the plurality of candidate DL beams. In one configuration, the network entity 1902 includes means for receiving a plurality of L1 signal quality measurements for the plurality of SSBs or the plurality of CSI-RSs, where the at least one DL beam is selected based on the plurality of L1 signal quality measurements. In one configuration, the network entity 1902 includes means for transmitting, for the UE, a TCI state update, where the TCI state update is associated with the at least one DL beam. In one configuration, the network entity 1902 includes means for transmitting, prior to receiving the at least one L1 signal quality measurement, a second configuration associated with a training process for the mapping function via a P2 beam refinement procedure for the SCell. In one configuration, the network entity 1902 includes means for receiving, based on the second configuration, a first plurality of L1 signal quality measurements for a plurality of SSBs or a plurality of CSI-RSs associated with the first cell. In one configuration, the network entity 1902 includes means for transmitting, for the UE, an indication of a plurality of candidate SSBs or a plurality of candidate CSI-RSs based on the first plurality of L1 signal quality measurements, where the plurality of candidate SSBs or the plurality of candidate CSI-RSs is associated with the SCell. In one configuration, the network entity 1902 includes means for receiving a subset of a second plurality of L1 signal quality measurements for the plurality of candidate SSBs or the plurality of candidate CSI-RSs. In one configuration, the network entity 1902 includes means for training the mapping function based on the subset of the second plurality of L1 signal quality measurements. In one configuration, the network entity 1902 includes means for selecting a number between zero and one hundred, inclusive. In one configuration, the network entity 1902 includes means for selecting the at least one DL beam based on the at least one L1 signal quality measurement and a mapping function if the number is greater than or equal to a threshold value. In one configuration, the network entity 1902 includes means for selecting the at least one DL beam based on a P2 beam refinement procedure for the SCell if the number is less than the threshold value. The means may be the BM component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

A SCell may be configured without a corresponding SSB (“a SSB-less SCell”) in order to provide for reduced energy consumption in a wireless communication system that supports multi-carrier operation. A UE may not be able to perform a L1-RSRP measurement on a SSB-less SCell (e.g., an inter-band SSB-less SCell) as the SSB-less SCell may not have a SSB to measure. As such, the UE may not be able to report information pertaining to DL beam management for the SSB-less SCell to a base station associated with the SSB-less SCell. Additionally, a DL beam of an anchor cell (e.g., a primary cell (PCell) or another SCell) associated with the base station may not be well-aligned with a DL beam associated with the SSB-less SCell when there is a relatively large carrier frequency separation (i.e., “beam squinting”) between a carrier of the anchor cell and a carrier of the SSB-less SCell.

Various technologies pertaining to beam management for a SSB-less SCell are described herein. In an example, a UE receives a configuration for reporting at least one L1 signal quality measurement for at least one SSB or at least one CSI-RS associated with a first cell. The UE transmits, based on the configuration, the at least one L1 signal quality measurement for the at least one SSB or the at least one CSI-RS associated with the first cell. The UE receives, based on the at least one L1 signal quality measurement, data or at least one signal via at least one DL beam associated with a SCell, where the SCell is not associated with a transmission of a corresponding SSB, where the first cell and the SCell are associated with different frequency bands. The L1 signal quality measurement(s) performed on the SSBs/CSI-RSs associated with the first cell may be utilized as a proxy for beam management purposes to select a DL beam associated with the SCell (i.e., a SSB-less SCell). Thus, the above-described technologies may be associated with increased communications reliability over SSB-less SCells by mitigating the effects of beam squinting. Additionally, the above-described technologies may facilitate beam management when a SCell is not associated with a SSB/CSI-RS transmission.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), including: receiving a configuration for reporting at least one layer 1 (L1) signal quality measurement for at least one synchronization signal block (SSB) or at least one channel-state information reference signal (CSI-RS) associated with a first cell; transmitting, based on the configuration, the at least one L1 signal quality measurement for the at least one SSB or the at least one CSI-RS associated with the first cell; and receiving, based on the at least one L1 signal quality measurement, data or at least one signal via at least one downlink (DL) beam associated with a secondary cell (SCell), where the SCell is not associated with a transmission of a corresponding SSB, where the first cell and the SCell are associated with different frequency bands.

Aspect 2 is the method of aspect 1, further including: receiving an indication that a network entity has selected the at least one DL beam associated with the SCell for transmission of the data or the at least one signal; and resetting at least one loop filter associated with the SCell based on the indication.

Aspect 3 is the method of aspect 2, where the at least one loop filter includes: an automatic gain control (AGC) loop, a time tracking loop, or a frequency tracking loop.

Aspect 4 is the method of any of aspects 1-3, further including: performing, subsequent to transmitting the at least one L1 signal quality measurement and as part of a procedure 2 (P2) beam refinement procedure for the SCell, a plurality of L1 signal quality measurements on a plurality of SSBs or a plurality of CSI-RSs associated with a plurality of candidate DL beams; transmitting the plurality of L1 signal quality measurements; and receiving a transmission configuration indication (TCI) state update based on the plurality of L1 signal quality measurements, where the TCI state update is associated with the at least one DL beam.

Aspect 5 is the method of any of aspects 1-4, further including: receiving, prior to transmitting the at least one L1 signal quality measurement, a second configuration associated with a training process for a mapping function via a procedure 2 (P2) beam refinement procedure for the SCell; performing, based on the second configuration, a first plurality of L1 signal quality measurements on a plurality of SSBs or a plurality of CSI-RSs associated with the first cell, where the plurality of SSBs or the plurality of CSI-RSs is associated with a plurality of DL beams; and transmitting the first plurality of L1 signal quality measurements.

Aspect 6 is the method of aspect 5, further including: receiving an indication of a plurality of candidate SSBs or a plurality of candidate CSI-RSs based on the plurality of L1 signal quality measurements, where the plurality of candidate SSBs or the plurality of candidate CSI-RSs is associated with the SCell; performing, based on the second configuration and the indication, a second plurality of L1 signal quality measurements on the plurality of candidate SSBs or the plurality of candidate CSI-RSs associated with the SCell; and transmitting a subset of the second plurality of L1 signal quality measurements, where the subset of the second plurality of L1 signal quality measurements is associated with a strongest L1 signal quality measurement from amongst the second plurality of L1 signal quality measurements.

Aspect 7 is the method of any of aspects 1-6, where the at least one L1 signal quality measurement for the at least one SSB or the at least one CSI-RS associated with the first cell is transmitted in a report, where the report includes an indication that a subset of the at least one SSB or the at least one CSI-RS were not detected.

Aspect 8 is the method of any of aspects 1-7, where the at least one L1 signal quality measurement includes at least one reference signal received power (RSRP) measurement.

Aspect 9 is the method of any of aspects 1-8, further including: performing, prior to transmitting the at least one L1 signal quality measurement and based on the configuration, the at least one L1 signal quality measurement.

Aspect 10 is the method of any of aspects 1-9, where the first cell is a primary cell (PCell) or a second SCell that is different from the SCell.

Aspect 11 is the method of any of aspects 1-10, where the configuration for reporting the at least one L1 signal quality measurement for the at least one SSB or the at least one CSI-RS indicates that the UE is to report a strongest L1 signal quality measurement for an SSB of the at least one SSB or a CSI-RS of the at least one CSI-RS from amongst the at least one L1 signal quality measurement for the at least one SSB or the at least one CSI-RS and at least one additional L1 measurement for at least one additional SSB of the at least one SSB or at least one additional CSI-RS of the at least one CSI-RS.

Aspect 12 is an apparatus for wireless communication at a user equipment (UE) including a memory and at least one processor coupled to the memory and based at least in part on information stored in the memory, the at least one processor is configured to perform a method in accordance with any of aspects 1-11.

Aspect 13 is an apparatus for wireless communications, including means for performing a method in accordance with any of aspects 1-11.

Aspect 14 is the apparatus of aspect 12 or 13 further including at least one of a transceiver or an antenna coupled to the at least one processor, where the at least one processor is configured to receive the data or the at least one signal via at least one of the transceiver or the antenna.

Aspect 15 is a computer-readable medium (e.g., a non-transitory computer-readable medium) including instructions that, when executed by an apparatus, cause the apparatus to perform a method in accordance with any of aspects 1-11.

Aspect 16 is a method of wireless communication at a network entity, including: transmitting, for a user equipment (UE), a configuration for reporting at least one layer 1 (L1) signal quality measurement for at least one synchronization signal block (SSB) or at least one channel-state information reference signal (CSI-RS) associated with a first cell; receiving, based on the configuration, the at least one L1 signal quality measurement for the at least one SSB or the at least one CSI-RS associated with the first cell; and transmitting, based on the at least one L1 signal quality measurement, data or at least one signal for the UE via at least one downlink (DL) beam associated with a secondary cell (SCell), where the SCell is not associated with a transmission of a corresponding SSB, where the first cell and the SCell are associated with different frequency bands.

Aspect 17 is the method of aspect 16, further including: selecting the at least one DL beam associated with the SCell out of a plurality of candidate DL beams based on the at least one L1 signal quality measurement, where the data or the at least one signal is transmitted based on the selected at least one DL beam.

Aspect 18 is the method of aspect 17, further including: transmitting, for the UE, an indication that the network entity has selected the at least one DL beam associated with the SCell for transmission of the data or the at least one signal.

Aspect 19 is the method of any of aspects 17-18, further including: transmitting, subsequent to receiving the at least one L1 signal quality measurement and as part of a procedure 2 (P2) beam refinement procedure for the SCell, a plurality of SSBs or a plurality of CSI-RSs associated with the plurality of candidate DL beams; and receiving a plurality of L1 signal quality measurements for the plurality of SSBs or the plurality of CSI-RSs, where the at least one DL beam is selected based on the plurality of L1 signal quality measurements.

Aspect 20 is the method of aspect 19, further including: transmitting, for the UE, a transmission configuration indication (TCI) state update, where the TCI state update is associated with the at least one DL beam.

Aspect 21 is the method of any of aspects 17-18, where the DL beam associated with the SCell is selected based on a mapping function between the first cell and the SCell, where the mapping function maps the at least one L1 signal quality measurement associated with the first cell to the at least one DL beam associated with the SCell.

Aspect 22 is the method of aspect 21, where the mapping function includes a look-up table or a non-linear function.

Aspect 23 is the method of any of aspects 21-22, further including: transmitting, prior to receiving the at least one L1 signal quality measurement, a second configuration associated with a training process for the mapping function via a procedure 2 (P2) beam refinement procedure for the SCell; and receiving, based on the second configuration, a first plurality of L1 signal quality measurements for a plurality of SSBs or a plurality of CSI-RSs associated with the first cell.

Aspect 24 is the method of aspect 23, further including: transmitting, for the UE, an indication of a plurality of candidate SSBs or a plurality of candidate CSI-RSs based on the first plurality of L1 signal quality measurements, where the plurality of candidate SSBs or the plurality of candidate CSI-RSs is associated with the SCell; receiving a subset of a second plurality of L1 signal quality measurements for the plurality of candidate SSBs or the plurality of candidate CSI-RSs; and training the mapping function based on the subset of the second plurality of L1 signal quality measurements.

Aspect 25 is the method of any of aspects 21-24, where the mapping function is constructed based on a cross-band beam calibration procedure.

Aspect 26 is the method of any of aspects 21-25, where the DL beam associated with the SCell is additionally selected based on a procedure 2 (P2) beam refinement procedure.

Aspect 27 is the method of any of aspects 16-25, further including: selecting a number between zero and one hundred, inclusive; selecting the at least one DL beam based on the at least one L1 signal quality measurement and a mapping function if the number is greater than or equal to a threshold value; and selecting the at least one DL beam based on a procedure 2 (P2) beam refinement procedure for the SCell if the number is less than the threshold value.

Aspect 28 is the method of any of aspects 16-27, where the at least one L1 signal quality measurement for the at least one SSB or the at least one CSI-RS associated with the first cell is received in a report, where the report includes an indication that a subset of the at least one SSB or the at least one CSI-RS were not detected.

Aspect 29 is the method of any of aspects 16-28, where the at least one L1 signal quality measurement includes at least one reference signal received power (RSRP) measurement.

Aspect 30 is the method of any of aspects 16-29, where the first cell is a primary cell (PCell) or a second SCell that is different from the SCell.

Aspect 31 is the method of any of aspects 16-30, where the configuration for reporting the at least one L1 signal quality measurement for the at least one SSB or the at least one CSI-RS indicates that the UE is to report a strongest L1 signal quality measurement for an SSB of the at least one SSB or a CSI-RS of the at least one CSI-RS from amongst the at least one L1 signal quality measurement and at least one additional L1 measurement for at least one additional SSB of the at least one SSB or at least one additional CSI-RS of the at least one CSI-RS.

Aspect 32 is an apparatus for wireless communication at a network entity including a memory and at least one processor coupled to the memory and based at least in part on information stored in the memory, the at least one processor is configured to perform a method in accordance with any of aspects 16-31.

Aspect 33 is an apparatus for wireless communications, including means for performing a method in accordance with any of aspects 16-31.

Aspect 34 is the apparatus of aspect 32 or 33 further including at least one of a transceiver or an antenna coupled to the at least one processor, where the at least one processor is configured to transmit the data or the at least one signal via at least one of the transceiver or the antenna.

Aspect 35 is a computer-readable medium (e.g., a non-transitory computer-readable medium) including instructions that, when executed by an apparatus, cause the apparatus to perform a method in accordance with any of aspects 16-31.

1. An apparatus for wireless communication at a user equipment (UE), comprising:
a memory; and
at least one processor coupled to the memory and, based at least in part on information stored in the memory, the at least one processor is configured to:
receive a configuration for reporting at least one layer 1 (L1) signal quality measurement for at least one synchronization signal block (SSB) or at least one channel-state information reference signal (CSI-RS) associated with a first cell;
transmit, based on the configuration, the at least one L1 signal quality measurement for the at least one SSB or the at least one CSI-RS associated with the first cell; and
receive, based on the at least one LI signal quality measurement, data or at least one signal via at least one downlink (DL) beam associated with a secondary cell (SCell), wherein the SCell is not associated with a transmission of a corresponding SSB, wherein the first cell and the SCell are associated with different frequency bands.

2. The apparatus of claim 1, wherein the at least one processor is further configured to:
receive an indication that a network entity has selected the at least one DL beam associated with the SCell for transmission of the data or the at least one signal; and
reset at least one loop filter associated with the SCell based on the indication.

3. The apparatus of claim 2, wherein the at least one loop filter includes:
an automatic gain control (AGC) loop,
a time tracking loop, or
a frequency tracking loop.

4. The apparatus of claim 1, wherein the at least one processor is further configured to:
perform, subsequent to the at least one processor being configured to transmit the at least one LI signal quality measurement and as part of a procedure 2 (P2) beam refinement procedure for the SCell, a plurality of LI signal quality measurements on a plurality of SSBs or a plurality of CSI-RSs associated with a plurality of candidate DL beams;
transmit the plurality of LI signal quality measurements; and
receive a transmission configuration indication (TCI) state update based on the plurality of LI signal quality measurements, wherein the TCI state update is associated with the at least one DL beam.

5. The apparatus of claim 1, wherein the at least one processor is further configured to:
receive, prior to the at least one processor being configured to transmit the at least one LI signal quality measurement, a second configuration associated with a training process for a mapping function via a procedure 2 (P2) beam refinement procedure for the SCell;
perform, based on the second configuration, a first plurality of LI signal quality measurements on a plurality of SSBs or a plurality of CSI-RSs associated with the first cell, wherein the plurality of SSBs or the plurality of CSI-RSs is associated with a plurality of DL beams; and
transmit the first plurality of LI signal quality measurements.

6. The apparatus of claim 5, wherein the at least one processor is further configured to:
receive an indication of a plurality of candidate SSBs or a plurality of candidate CSI-RSs based on the plurality of LI signal quality measurements, wherein the plurality of candidate SSBs or the plurality of candidate CSI-RSs is associated with the SCell;
perform, based on the second configuration and the indication, a second plurality of LI signal quality measurements on the plurality of candidate SSBs or the plurality of candidate CSI-RSs associated with the SCell; and
transmit a subset of the second plurality of LI signal quality measurements, wherein the subset of the second plurality of LI signal quality measurements is associated with a strongest LI signal quality measurement from amongst the second plurality of LI signal quality measurements.

7. The apparatus of claim 1, wherein the at least one LI signal quality measurement for the at least one SSB or the at least one CSLRS associated with the first cell is configured to be transmitted in a report, wherein the report includes an indication that a subset of the at least one SSB or the at least one CSLRS were not detected.

8. (canceled)

9. (canceled)

10. (canceled)

11. (canceled)

12. (canceled)

13. A method of wireless communication at a user equipment (UE), comprising:
receiving a configuration for reporting at least one layer 1 (LI) signal quality measurement for at least one synchronization signal block (SSB) or at least one channelstate information reference signal (CSLRS) associated with a first cell;
transmitting, based on the configuration, the at least one LI signal quality measurement for the at least one SSB or the at least one CSI-RS associated with the first cell; and
receiving, based on the at least one LI signal quality measurement, data or at least one signal via at least one downlink (DL) beam associated with a secondary cell (SCell), wherein the SCell is not associated with a transmission of a corresponding SSB, wherein the first cell and the SCell are associated with different frequency bands.

14. An apparatus for wireless communication at a network entity, comprising:
a memory; and
at least one processor coupled to the memory and, based at least in part on information stored in the memory, the at least one processor is configured to:
transmit, for a user equipment (UE), a configuration for reporting at least one layer 1 (LI) signal quality measurement for at least one synchronization signal block (SSB) or at least one channel-state information reference signal (CSLRS) associated with a first cell;
receive, based on the configuration, the at least one LI signal quality measurement for the at least one SSB or the at least one CSLRS associated with the first cell; and
transmit, based on the at least one LI signal quality measurement, data or at least one signal for the UE via at least one downlink (DL) beam associated with a secondary cell (SCell), wherein the SCell is not associated with a transmission of a corresponding SSB, wherein the first cell and the SCell are associated with different frequency bands.

15. The apparatus of claim 14, wherein the at least one processor is further configured to:
select the at least one DL beam associated with the SCell out of a plurality of candidate DL beams based on the at least one LI signal quality measurement, wherein the at least one processor is configured to transmit the data or the at least one signal based on the selected at least one DL beam.

16. The apparatus of claim 15, wherein the at least one processor is further configured to:
transmit, for the UE, an indication that the network entity has selected the at least one DL beam associated with the SCell for transmission of the data or the at least one signal.

17. The apparatus of claim 15, wherein the at least one processor is further configured to:
transmit, subsequent to the at least one processor being configured to receive the at least one LI signal quality measurement and as part of a procedure 2 (P2) beam refinement procedure for the SCell, a plurality of SSBs or a plurality of CSLRSs associated with the plurality of candidate DL beams; and
receive a plurality of LI signal quality measurements for the plurality of SSBs or the plurality of CSLRSs, wherein the at least one DL beam is selected based on the plurality of LI signal quality measurements.

18. The apparatus of claim 17, wherein the at least one processor is further configured to:
transmit, for the UE, a transmission configuration indication (TCI) state update, wherein the TCI state update is associated with the at least one DL beam.

19. The apparatus of claim 15, wherein the at least one processor is configured to select the DL beam associated with the SCell based on a mapping function between the first cell and the SCell, wherein the mapping function is configured to map the at least one LI signal quality measurement associated with the first cell to the at least one DL beam associated with the SCell.

20. The apparatus of claim 19, wherein the mapping function comprises a look-up table or a non-linear function.

21. The apparatus of claim 19, wherein the at least one processor is further configured to:
transmit, prior to the at least one processor being configured to receive the at least one LI signal quality measurement, a second configuration associated with a training process for the mapping function via a procedure 2 (P2) beam refinement procedure for the SC ell; and
receive, based on the second configuration, a first plurality of LI signal quality measurements for a plurality of SSBs or a plurality of CSI-RSs associated with the first cell.

22. The apparatus of claim 21, wherein the at least one processor is further configured to:
transmit, for the UE, an indication of a plurality of candidate SSBs or a plurality of candidate CSI-RSs based on the first plurality of LI signal quality measurements, wherein the plurality of candidate SSBs or the plurality of candidate CSI-RSs is associated with the SCell;
receive a subset of a second plurality of LI signal quality measurements for the plurality of candidate SSBs or the plurality of candidate CSI-RSs; and
train the mapping function based on the subset of the second plurality of LI signal quality measurements.

23. The apparatus of claim 19, wherein the mapping function is constructed based on a cross-band beam calibration procedure.

24. (canceled)

25. The apparatus of claim 14, wherein the at least one processor is further configured to:
select a number between zero and one hundred, inclusive;
select the at least one DL beam based on the at least one LI signal quality measurement and a mapping function if the number is greater than or equal to a threshold value; and
select the at least one DL beam based on a procedure 2 (P2) beam refinement procedure for the SCell if the number is less than the threshold value.

26. The apparatus of claim 14, wherein the at least one processor is configured to receive the at least one LI signal quality measurement for the at least one SSB or the at least one CSLRS associated with the first cell in a report, wherein the report includes an indication that a subset of the at least one SSB or the at least one CSLRS were not detected.

27. (canceled)

28. (canceled)

29. (canceled)

30. (canceled)
